(19) United States
(12) Patent Application Publication
(10) Pub. No.: US 2021/0124479 A1
(43) Pub. Date: Apr. 29, 2021

(54) MULTI-CHANNEL COMMUNICATOR SYSTEM

(71) Applicant: Nabil Atieh, Doha (QA)

(72) Inventor: Nabil Atieh, Doha (QA)

(21) Appl. No.: 17/117,943

(22) Filed: Dec. 10, 2020

Related U.S. Application Data
(60) Provisional application No. 62/946,672, filed on Dec. 11, 2019.

(51) Int. Cl. G06F 3/0484; G06F 21/31; G06F 21/84; H04L 29/08; H04W 4/029

(52) U.S. Cl. CPC G06F 3/04845; G06F 3/04842; G06F 21/31; H04W 4/029; H04L 67/306; H04L 67/36; G06F 21/84

(57) ABSTRACT

A multi-channel communicator may include systems, devices and methods having a hardware processor, physical memory and a hardware display to provide various operations such as to compare a first user input associated with profile information, recognize the first user input as being associated with a baseline profile, launch the baseline user profile corresponding to the user first input, receive a second user input associated with at least one privacy selection, and update the baseline profile based on the first and second user inputs.

### CROSS-REFERENCE TO RELATED APPLICATIONS

This application is a U.S. Non-Provisional Patent Application that is based on and claims priority to Provisional Application No. 62/946,672 filed Dec. 11, 2019 titled “MULTI-CHANNEL COMMUNICATOR SYSTEM,” the contents of which are hereby incorporated by reference in their entirety.

### BACKGROUND

Traditional technologies are prone to a variety of communication, privacy and language issues. These require users to maintain multiple different accounts and applications for various personal and business environments. Sensitive information is communicated to and from these traditional accounts with substantial privacy risks. Further, traditional systems exploit and sell user information, again to the detriment of user privacy. Typical systems also lack the capacity to maintain multiple profiles with various privacy levels responsive to the real-time privacy demands of users. Traditional systems are limited to the communication capacity of users and thus lack mechanisms for automatically bridging language barriers during real-time discussions.

There is a need for improved systems, methods and devices that provide operations with practical applications including enhanced communication, privacy and language capabilities to address the above and other issues. The present disclosure provides a multi-channel communicator to consolidate, streamline, improve, and overcome the shortcomings of traditional technologies.

### BRIEF DESCRIPTION OF THE DRAWINGS

FIG. 1 illustrates embodiments of an exemplary hardware system of the present disclosure;

FIG. 2 illustrates embodiments of an exemplary operational system of the present disclosure;

FIG. 3 illustrates embodiments of an exemplary user interface of the present disclosure including, e.g., providing general and multi-channel privacy operations, and generating, transferring and displaying associated information such as user, profile, sensor and/or mood information;

FIG. 4 illustrates embodiments of an exemplary user interface of the present disclosure including, e.g., providing general and multi-channel security operations, and generating, transferring and displaying the associated information;

FIG. 5 illustrates embodiments of an exemplary user interface of the present disclosure including, e.g., providing multi-channel privacy, blocking, location and security operations, and generating, transferring and displaying the associated information;

FIG. 6 illustrates embodiments of an exemplary user interface of the present disclosure including, e.g., providing multi-channel visibility operations, and generating, transferring and displaying the associated information;

FIG. 7 illustrates embodiments of an exemplary user interface of the present disclosure including, e.g., providing multi-channel visibility operations, and generating, transferring and displaying the associated information;

FIG. 8 illustrates embodiments of an exemplary user interface of the present disclosure including, e.g., providing multi-channel contact selection operations, and generating, transferring and displaying the associated information;

FIG. 9 illustrates embodiments of an exemplary user interface of the present disclosure including, e.g., providing multi-channel communications operations, and generating, transferring and displaying the associated information;

FIG. 10 illustrates embodiments of an exemplary user interface of the present disclosure including, e.g., providing multi-channel communications operations, and generating, transferring and displaying the associated information;

FIG. 11 illustrates embodiments of an exemplary user interface of the present disclosure including, e.g., providing multi-channel masking operations, and generating, transferring and displaying the associated information;

FIG. 12 illustrates embodiments of an exemplary user interface of the present disclosure including, e.g., providing multi-channel masking activation operations, and generating, transferring and displaying the associated information;

FIG. 13 illustrates embodiments of an exemplary user interface of the present disclosure including, e.g., providing multi-channel masking deactivation operations, and generating, transferring and displaying the associated information;

FIG. 14 illustrates embodiments of an exemplary user interface of the present disclosure including, e.g., providing access operations, and generating, transferring and displaying the associated information;

FIG. 15 illustrates embodiments of an exemplary user interface of the present disclosure including, e.g., providing masked text, images and location operations, and generating, transferring and displaying the associated information;

FIG. 16 illustrates embodiments of an exemplary user interface of the present disclosure including, e.g., providing multi-channel group operations, and generating, transferring and displaying the associated information;

FIG. 17 illustrates embodiments of an exemplary user interface of the present disclosure including, e.g., providing multi-channel group call operations, and generating, transferring and displaying the associated information;

FIG. 18 illustrates embodiments of an exemplary user interface of the present disclosure including, e.g., providing multi-channel group call operations, and generating, transferring and displaying the associated information;

FIG. 19 illustrates embodiments of an exemplary user interface of the present disclosure including, e.g., providing multi-channel pin and block operations, and generating, transferring and displaying the associated information;

FIG. 20 illustrates embodiments of an exemplary user interface of the present disclosure including, e.g., providing multi-channel unpin and unblock operations, and generating, transferring and displaying the associated information;

FIG. 21 illustrates embodiments of an exemplary user interface of the present disclosure including, e.g., providing menu operations, and generating, transferring and displaying the associated information;

FIGS. 22 illustrates embodiments of an exemplary user interface of the present disclosure including, e.g., providing multi-channel communication scheduling operations, and generating, transferring and displaying the associated information;

FIG. 23 illustrates embodiments of an exemplary user interface of the present disclosure including, e.g., providing scheduling notification operations, and generating, transferring and displaying the associated information;

FIG. 24 illustrates embodiments of an exemplary user interface of the present disclosure including, e.g., providing multi-channel automatic or on-demand translation selection operations, and generating, transferring and displaying the associated information;

FIG. 25 illustrates embodiments of an exemplary user interface of the present disclosure including, e.g., providing multi-channel automatic or on-demand translation operations, and generating, transferring and displaying the associated information;

FIG. 26 illustrates embodiments of an exemplary user interface of the present disclosure including, e.g., providing multi-channel automatic or on-demand translation operations, and generating, transferring and displaying the associated information;

FIG. 27 illustrates embodiments of an exemplary user interface of the present disclosure including, e.g., providing multi-channel broadcast operations, and generating, transferring and displaying the associated information;

FIG. 28 illustrates embodiments of an exemplary user interface of the present disclosure including, e.g., providing multi-channel broadcast activation operations, and generating, transferring and displaying the associated information;

FIG. 29 illustrates embodiments of an exemplary user interface of the present disclosure including, e.g., providing multi-channel broadcast selection operations, and generating, transferring and displaying the associated information;

FIG. 30 illustrates embodiments of an exemplary user interface of the present disclosure including, e.g., providing multi-channel broadcast operations, and generating, transferring and displaying the associated information;

FIG. 31 illustrates embodiments of an exemplary user interface of the present disclosure including, e.g., providing multi-channel broadcast operations, and generating, transferring and displaying the associated information;

FIG. 32 illustrates embodiments of an exemplary user interface of the present disclosure including, e.g., providing multi-channel broadcast operations, and generating, transferring and displaying the associated information;

FIG. 33 illustrates embodiments of an exemplary user interface of the present disclosure including, e.g., providing selection operations, and generating, transferring and displaying the associated information;

FIG. 34 illustrates embodiments of an exemplary user interface of the present disclosure including, e.g., providing operations, and generating, transferring and displaying the associated information;

FIG. 35 illustrates embodiments of an exemplary user interface of the present disclosure including, e.g., providing user profile pattern and quick launch operations, and generating, transferring and displaying the associated information;

FIG. 36 illustrates embodiments of an exemplary user interface of the present disclosure including, e.g., providing multi-channel profile selection operations, and generating, transferring and displaying the associated information;

FIG. 37 illustrates embodiments of an exemplary process of the present disclosure;

FIG. 38 illustrates embodiments of an exemplary user interface of the present disclosure, e.g., providing multi-channel online and offline selections;

FIG. 39 illustrates embodiments of an exemplary user interface of the present disclosure, e.g., providing online and offline selections;

FIG. 40 illustrates embodiments of an exemplary user interface of the present disclosure, e.g., providing user mood information;

FIG. 41 illustrates embodiments of an exemplary user interface of the present disclosure, e.g., providing user mood information;

FIG. 42 illustrates embodiments of an exemplary user interface of the present disclosure, e.g., providing user mood information;

FIG. 43 illustrates embodiments of an exemplary user interface of the present disclosure, e.g., providing a burning message;

FIG. 44 illustrates embodiments of an exemplary user interface of the present disclosure, e.g., providing a burning message;

FIG. 45 illustrates embodiments of an exemplary user interface of the present disclosure, e.g., providing a burning message;

FIG. 46 illustrates embodiments of an exemplary user interface of the present disclosure, e.g., providing a burning message;

FIG. 47 illustrates embodiments of an exemplary user interface of the present disclosure, e.g., defining a predefined or user-defined duration for a burning message;

FIG. 48 illustrates embodiments of an exemplary user interface of the present disclosure, e.g., displaying a burning message;

FIG. 49 illustrates embodiments of an exemplary user interface of the present disclosure, e.g., displaying disappearance of a burning message;

FIG. 50 illustrates embodiments of an exemplary user interface of the present disclosure, e.g., displaying a burned or cleared message area;

FIG. 51 illustrates embodiments of an exemplary user interface of the present disclosure, e.g., providing a mood profile selections;

FIG. 52 illustrates embodiments of an exemplary user interface of the present disclosure, e.g., providing a mood profile selections;

FIG. 53 illustrates embodiments of an exemplary user interface of the present disclosure, e.g., providing a mood profile selections;

FIG. 54 illustrates embodiments of an exemplary user interface of the present disclosure, e.g., providing a mood profile selections;

FIG. 55 illustrates embodiments of an exemplary user interface of the present disclosure, e.g., providing a mood profile selections;

FIG. 56 illustrates embodiments of an exemplary user interface of the present disclosure, e.g., providing channel selections;

FIG. 57 illustrates embodiments of an exemplary user interface of the present disclosure, e.g., providing channel selections;

FIG. 58 illustrates embodiments of an exemplary user interface of the present disclosure, e.g., providing channel selections;

FIG. 59 illustrates embodiments of an exemplary user interface of the present disclosure, e.g., providing channel selections;

FIG. 60 illustrates embodiments of an exemplary user interface of the present disclosure, e.g., providing channel selections;

FIG. 61 illustrates embodiments of an exemplary user interface of the present disclosure, e.g., providing channel information;

FIG. 62 illustrates embodiments of an exemplary user interface of the present disclosure, e.g., providing channel search optimization;

FIG. 63 illustrates embodiments of an exemplary user interface of the present disclosure, e.g., providing channel search optimization;

FIG. 64 illustrates embodiments of an exemplary user interface of the present disclosure, e.g., providing channel search optimization;

FIG. 65 illustrates embodiments of an exemplary user interface of the present disclosure, e.g., providing channel search optimization;

FIG. 66 illustrates embodiments of an exemplary user interface of the present disclosure, e.g., providing channel search optimization;

FIG. 67 illustrates embodiments of an exemplary user interface of the present disclosure, e.g., providing channel search optimization;

FIG. 68 illustrates embodiments of an exemplary user interface of the present disclosure, e.g., providing channel search optimization;

FIG. 69 illustrates embodiments of an exemplary user interface of the present disclosure, e.g., providing channel search optimization;

FIG. 70 illustrates embodiments of an exemplary user interface of the present disclosure, e.g., providing channel search optimization; and

FIG. 71 illustrates embodiments of an exemplary process of the present disclosure.

### DETAILED DESCRIPTION

A multi-channel communicator system may provide a user interface including a hardware processor, physical memory and a hardware display. The system may include operations to compare a first user input associated with profile information, recognize the first user input as being associated with a baseline profile, launch the baseline user profile corresponding to the user first input, receive a second user input associated with at least one privacy selection, and update the baseline profile based on the first and second user inputs. The system may prompt for and receive one or more content selections. The system may prompt for and receive at least one of an activation selection and a deactivation selection for a ghost or masked profile associated with the baseline profile, and masking or not masking the baseline profile in response to the respective selection. The system may determine a user location by way of location positioning device, and determine that the user location is at least one of within and outside the user-predefined geofence. The system may prompt for and receive a third user input to launch a second profile configured to mask the baseline profile. The system may prompt for and receive a third user input including at least one of a language selection, a communication type, and a send date, and initiate a communication session based on the first, second and third user inputs. The system may receive sensor information associated with one or more users, and update one or more user profiles based on the sensor information. The system may include or incorporate associated devices and methods.

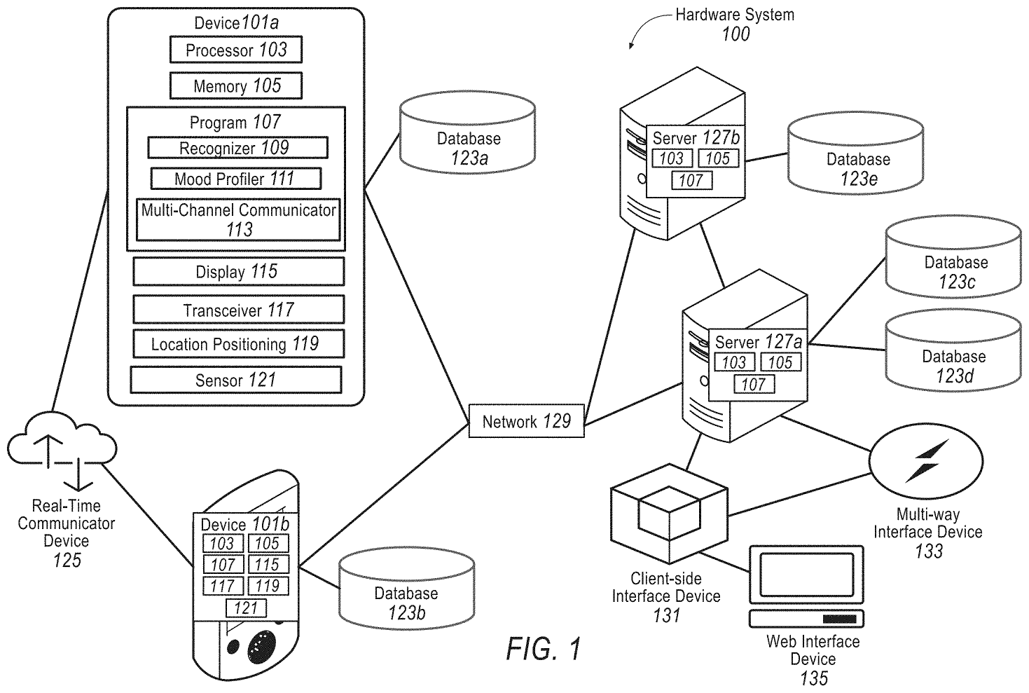

FIG. 1 illustrates an exemplary system 100, for example, a hardware system. System 100 may take many different forms and include multiple and/or alternate components and operations. While an exemplary system 100 is shown in the figure, the exemplary components illustrated are not intended to be limiting. Indeed, additional or alternative components and/or implementations may be used.

As illustrated in FIG. 1, the system 100 may include one or more devices 101 (e.g., user interface devices 101a-b), a processor 103 (e.g., a hardware processor), memory 105 (e.g., physical memory), program 107, display 115 (e.g., a hardware display), transceiver 117, location positioning device 119, sensor 121, one or more databases 123a-e (e.g., databases 123a-e), real-time communicator device 125, one or more servers 127 (e.g., servers 127a-b), network 129, client-side interface device 131, multi-way interface device 133, and web interface device 135. The program 107 may include recognizer 109, mood profiler 111, and multi-channel communicator 113 configured to individually or collaboratively provide any or all of the operations disclosed herein.

All or any portion of system 100, e.g., servers 127a-b and devices 101a-b, may include processor 103 and memory 105 including program 107 providing one or more user interfaces (e.g., by way of display 115) that are generated by way of instructions (e.g., on memory 105) that when executed (e.g., by processor 103) provide the operations described herein.

The system 100 may be configured to transfer information throughout any or all of its components by way of wired and/or wireless connections therebetween. The system 100, e.g., devices 101a-b and servers 127a-b, may be configured to receive and send (e.g., using transceiver 117), display and receive (e.g., information and user inputs using display 115), transfer (e.g., using transceiver 117 and/or network 129), compare (e.g., using processor 103), and store (e.g., using memory 105 and/or one or more databases 123a-e) information with respect to servers 127a-b and devices 101a-b. The memory 105 and databases 123a-e may all or any portion of the information or operations herein.

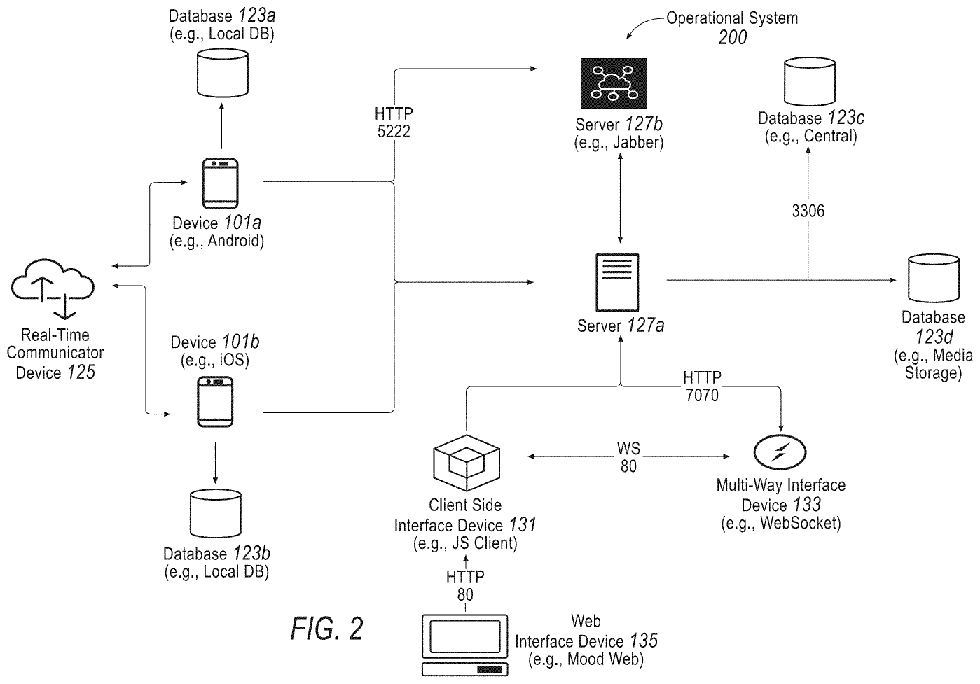

As shown in FIG. 2, embodiments of system 100 may operationally arranged according to operational system 200. Device 101a and device 101b may exchange information with real-time communicator device 125, e.g., using an application programming interface (API) for real-time communication such as WebRTC. Device 101a may include a first operating system and device 101b may include a second operating system, e.g., any one or combination of operating systems. Devices 101a-b may exchange text, audio, tactile, sensor, and/or video information with each other, e.g., by way of real-time communicator device 125.

Devices 101a-b may exchange information with servers 127a-b. Device 101 may communicate with server 127b (e.g., an extensible messaging and presence protocol (XMPP) server such as Jabber), e.g., by way of HTTP 5222. Server 127b may exchange information with server 127a. Server 127a may transfer and store information to database 123c (e.g., central or main storage) and database 123d (e.g., media storage). Server 127a may be in communication with client-side interface device 131 (e.g., JavaScript) and multi-way interface device 133, e.g., by way of HTTP 7070. Client side interface device 131 may be in communication with multi-way interface device 133 (e.g., using a full-duplex communication protocol such as WebSocket), e.g., by way of WS 80. Client-side interface device 131 may be in communication with web interface device 135 (e.g., Mood Web), e.g., by way of HTTP 80.

The system 100 may include network 129. Network 129 may be configured to provide the infrastructure through which the servers 127a-b, devices 101a-b, and one or more databases 123a-e may communicate, for example, to define, generate, distribute, compare, and adapt information such as user, profile, sensor and/or mood information. For instance, network 127 may be or include an infrastructure that generally includes edge, distribution, and core devices (e.g., servers 127a-b) and enables a path (e.g., wired and/or wireless connections) for the exchange of information between different devices and systems (e.g., between servers 127a-b, devices 101a-b, and one or more databases 123a-e). In general, a network (e.g., system 100 or network 129) may be a collection of computers and other hardware to provide infrastructure to establish connections and carry communications.

The system 100 may utilize network 129 with any networking technology to provide connections between any of network 129, servers 127a-b, devices 101a-b, and one or more databases 123a-e. The connections may be any wired or wireless connections between two or more endpoints (e.g., devices or systems), for example, to facilitate transfer of information between any portions of system 100. System 100 may utilize transceiver 117 in communication with network 129, e.g., any wired or wireless network. The network 129 may include a packet network or any other network having an infrastructure to carry communications. Network 129 may be configured to provide communications services to and between a plurality of devices (e.g., servers 127a-b and devices 101a-b).

The servers 127a-b may include any computing system configured to communicatively connect with the devices 101 and one or more databases 123a-e. The servers 127a-b may be connected, via wired or wireless connections, to the network 129, devices 101, and one or more databases 123a-e. Servers 127a-b may be in continuous or periodic communication with devices 101. Servers 127a-b may include a local, remote, or cloud-based server and may be in communication with devices 101a-b and receive information from one or more databases 123a-ea-e. The servers 127a-b may further provide a web-based user interface (e.g., an internet portal) to be displayed by any of the display 115 of device 101. In addition, the servers 127a-b may be configured to store information as part of memory 105 as part of servers 127a-b or one or more databases 123a-e connected to servers 127a-b. The servers 127a-b may include a single or a plurality of centrally or geographically distributed servers 127.

Devices 101a-b may be configured to provide user interfaces 300 as part of display 115 and configured to be generated by processor 103. The user interfaces 300 may include one or a plurality of user profiles associated with a computer operating system of the device 101. The device 101 may include one or a plurality of user interfaces 300, e.g., each being associated with a different user or user profile. The user interfaces 300 may be launched using the processor 103 and displayed as part of the display 115. The user interfaces 300 may include and display one or more applications.

Any portion of system 100 (e.g., servers 127a-b and devices 101a-b) may include a computing system and/or device that includes processor 103 and memory 105. Computing systems and/or devices generally include computer-executable instructions, wherein the instructions may be executable by one or more devices such as those disclosed herein. Computer-executable instructions may be compiled or interpreted from computer programs created using a variety of programming languages and/or technologies, including, without limitation, and either alone or in combination, Java™, C, C++, Visual Basic, Java Script, Perl, etc. The system 100 and servers 127a-b, devices 101a-b, and one or more databases 123a-e may take many different forms and include multiple and/or alternate components and facilities, as illustrated in the Figures further described below. While exemplary systems, devices, modules, and sub-modules are shown in the figures, the exemplary components illustrated in the figures are not intended to be limiting. Indeed, additional or alternative components and/or implementations may be used, and thus the above communication operation examples should not be construed as limiting.

In general, computing systems and/or devices (e.g., servers 127a-b and devices 101a-b) may employ any of a number of computer operating systems, including, but by no means limited to, versions and/or varieties of Microsoft Windows, Unix, AIX UNIX, Linux, Android, Apple iOS and BlackBerry OS. Examples of computing systems and/or devices include, without limitation, mobile devices, cellular phones, smart-phones, super-phones, tablet computers, next generation portable devices, mobile printers, handheld computers, notebooks, laptops, desktops, computer workstations, a server, secure voice communication equipment, networking hardware, or any other computing system and/or device.

Further, processors such as processor 103 receives instructions from memories such as memory 105 or one or more databases 123a-e and executes the instructions, thereby performing one or more processes, including one or more of the processes described herein. Such instructions and information may be stored and transmitted using a variety of computer-readable mediums (e.g., memory 105 or one or more databases 123a-e). Processors such as processor 103 may include processes comprised from any hardware, software, or combination of hardware or software that carries out instructions of one or more computer programs by performing logical and arithmetical calculations, such as adding or subtracting two or more numbers, comparing numbers, or jumping to a different part of the instructions. For example, the processor 103 may be any one of, but not limited to single, dual, triple, or quad core processors (on one single chip), graphics processing units, visual processing units, and virtual processors.

A memory such as memory 105 or one or more databases 123a-e may include, in general, any computer-readable medium (also referred to as a processor-readable medium) that may include any non-transitory (e.g., tangible) medium that participates in providing information or instructions that may be read by a computer (e.g., by the processors 105 of the servers 127a-b and devices 101a-b). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The servers 127a-b and devices 101a-b may include processor 103 that is configured to perform operations with respect to the information, e.g., of memory 105 or one or more databases 123a-e. The server 127 (e.g., servers 127a-b) and device 101 (e.g., devices 101a-b) may further utilize the processor 103 and/or transceiver 117 to store, transfer, access, compare, synchronize, and map information between memory 105 and database 123. Further, databases, data repositories or other information stores (e.g., memory 105 and one or more databases 123a-e) described herein may generally include various kinds of mechanisms for transferring, storing, accessing, and retrieving various kinds of information, including a hierarchical database, a set of files in a file system, an application database in a proprietary format, a relational database management system (RDBMS), etc. Each such information store may generally be included as part of memory 105 or one or more databases 123a-e (e.g., external to, local to, or remote from the servers 127a-b and devices 101a-b) and may be accessed with a computing system and/or device (e.g., servers 127a-b and devices 101a-b) employing a computer operating system such as one of those mentioned above, and/or accessed via a network (e.g., system 100 or network 129) or connection in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

The computing systems herein may include any electronic hardware that includes a processor 103, memory 105 and/or transceiver 117 that is capable of performing the operations discussed herein including the transfer, synchronization and adaptation of information as well as providing access to a target display area in response to user inputs. For the operations herein, the computing systems herein may be configured to utilize communications technologies including, without limitation, any wired or wireless communication technology, such as cellular, near field communication (NFC), Bluetooth®, Wi-Fi, and radiofrequency (RF) technologies. Communication technologies may include any technology configured to exchange electronic information by converting propagating electromagnetic waves to and from conducted electrical signals.

The display 115 may include a hardware display configured to present or display user interfaces 300. The devices 101a-b may each include the same or a different display 115. The display 115 may include a computer display, support user interfaces, and/or communicate within the system 100. The display 115 may include any input-output device for the transfer and presentation of information in visual or tactile form. Examples of a display may include, without limitation, cathode ray tube display, light-emitting diode display, electroluminescent display, touchscreen, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, or a combination thereof

Transceiver 117 may communicatively connect the devices of system 100, for example, using any type of wired or wireless network connection (e.g., wired or wireless connections). The wireless network may utilize a wireless transmitter (e.g., cellular, radiofrequency (RF) or Wi-Fi transmitter) of transceiver 117. Transceiver 117 may be configured to communicatively connect any or all of network 129, servers 127a-b, and devices 101a-b. Transceiver 117 may be used for digital or analog signal transfers. For instance, transceiver 117 may include any antenna technology including cellular, radiofrequency (RF), near field communication (NFC), Bluetooth, Wi-Fi, or the like. Transceiver 117 may include any technology that implements a wireless exchange of information by converting propagating electromagnetic waves to and from conducted electrical signals. Transceiver 117 may include any technology that is used to exchange information wirelessly using radio waves over a radio range or network that enables communication.

Location positioning device 119 may include any location determination technology that enables the determination of location information (e.g., a current geographic position) of any of devices 101a-b. Processor 103 may determine relative location relative to a user-predefined area, e.g., relative location within or outside a geofence. Examples of location determination technology may include, without limitation, global positioning systems (GPS), indoor positioning system, local positioning system, and mobile phone tracking. Location positioning device 119 may be configured to provide a current geographic position of any of devices 101a-b.

Sensor 121 may be part of and/or in communication with devices 101a-b. The sensor 121 may include any wired or wireless sensor including, e.g., any tactile, vibration, audio, optical, health, wearable, contact, or non-contact sensor. The sensor 121 may include a vibration, acoustic, noise, touch, capacitive, tactile, biofeedback, facial recognition, voice recognition, transducer, gyro, piezoelectric, geophone, hydrophone, lace, microphone, seismometer, sound locator, position, shock, tilt, flex, optical, fiber optic, light, LED, pressure, load cell, touch, motion, proximity, triangulation, altitude, or ultrasonic sensor or any combination thereof. The device 101 may be configured to respond to one or more user-predefined thresholds associated with the sensor outputs of sensor 121. The sensor 121 may be part of device 101 and/or in communication with transceiver 117 and/or network 129. Sensor 121 may be in communication with devices 101a-b, servers 127a-b and/or network 129. Sensor 121 may include any sensor configured to measure, monitor or initiate operations in response to the user of device 101a, device 101b or a combination thereof. Sensor 121 may be configured to communicate one or more sensor outputs to any portion of system 100. The sensor 121 of device 101a may communicate in real-time, near real-time, periodically, or based on user inputs. User-predefined sensor outputs may be defined by the user and/or stored on memory 105 and/or databases 123. Sensor 121 may monitor one or more users of devices 101a-b and generate the sensor outputs in response to the same to provide any or all of the operations herein.

System 101 may prompt for and receive by display 115 user inputs associating a user-predefined action with one or more sensor inputs and/or outputs. For example, the sensor 121 may be configured to respond to a user-predefined threshold, e.g., sound or vibration from a user. Device 101 may prompt for and receive a user-predefined action including the user vibrating or shaking device 101, and a sensor output of changing the user profile on display 115, e.g., between user-predefined general, official, business, personal, private, and/or ghost or masked profiles. For example, device 101 may use sensor 121 to monitor sound and/or vibration of the user, and change from a baseline profile such as general profile to a ghost or masked profile in response to the sound or vibration, or vice versa.

The user-predefined threshold may multi-level thresholds. The device 101 may prompt for and/or receive by display 115 low, intermediate, and high levels associated with selective or different sensor outputs. Device 101 may provide no response or user-predefined responses to sensor information corresponding to the low, intermediate and/or high-level thresholds.

Device 101 may be configured to define and invoke sensor inputs and/or outputs in response to user inputs as accordingly to user-predefined actions or objectives, e.g., automatically initiating, adapting, or switching between any of the operations in response to sensor information of sensor 121. For example, device 101 may include sensor 121 configured to measure vibration or shaking of device 101 and cause processor 103 to provide operations including to automatically switch user interface 300 between unmasked and masked profiles. Device 101 may be configured to invoke first user-predefined outputs (e.g., no action) in response to sensor information associated with the low-level threshold, e.g., sensor information associated with environmental or background noise around the user. The device 101 may be configured to invoke second user-predefined outputs in response to sensor information associated with the intermediate level threshold, e.g., automatically changing from the baseline profile to a ghost or masked profile in response to a user-predefined activity (e.g., a user-predefined motion such as shaking, the user location being within or outside a user-predefined geofence, or user-predefined noise or speech such as saying “ghost or masked profile”). The device 101 may be configured to invoke third user-predefined outputs in response to sensor information associated with the high-level threshold, e.g., automatically contacting a user-predefined contact, authorities, medical assistance, and/or a device owner or manufacturer in response to sensor information indicating tampering or damage to device 101, heath changes in the user, or a combination thereof.

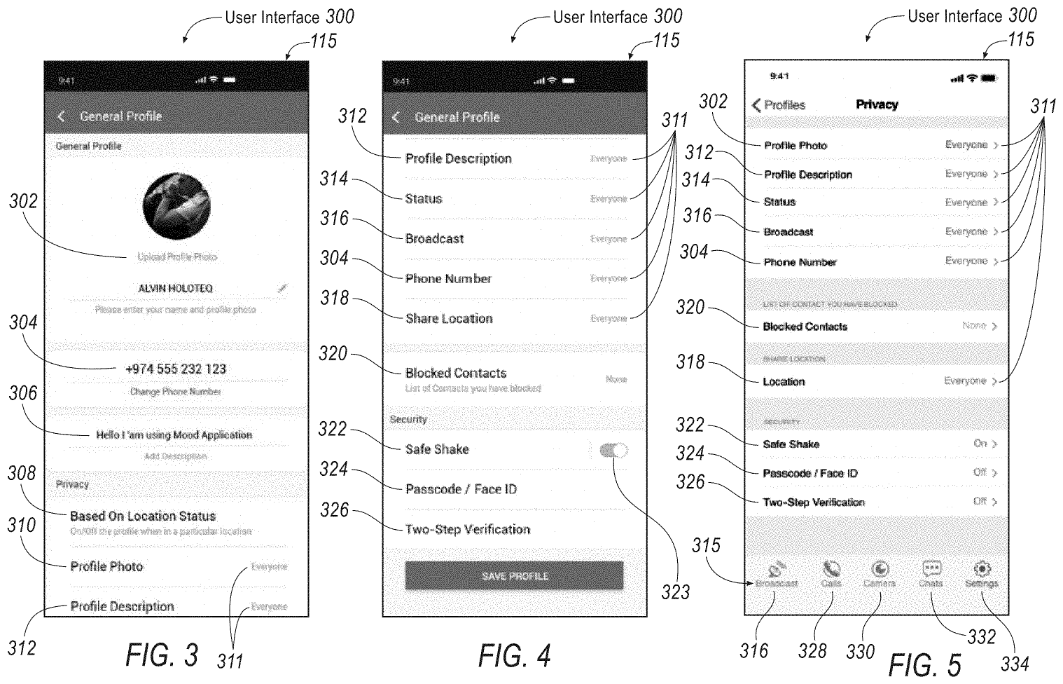

FIGS. 3-36 illustrate exemplary embodiments of user interface 300. User interface 300 may include display device 115 configured to present and display information, receive user inputs, and provide the operations disclosed herein. With embodiments, user interface 300 may include visibility selections, advanced message scheduling, automatic or on-demand translations, and interactive broadcasting. User interface 300 may take many different forms and include multiple and/or alternate components and/or implementations. While an exemplary device is shown in the figures, the illustrations are not intended to be limiting. Indeed, additional or alternative components and/or implementations may be used.

As illustrated in FIG. 3, embodiments of user interface 300 may include any or all of profile selector 302 (e.g., define profile name and select profile image for a user), user number 304 (e.g., define phone number for the user), description 306 (e.g., define profile description for the user), location-based status 308 (e.g., define or select profile with connectivity and/or appearance as online or offline in response to one or more user-predefined locations), profile photo visibility 310, profile description visibility 312, and one or more associated threshold selectors 311. User interface 300 may be configured to create one or a plurality of user profiles, e.g., general, official, business, personal, private, ghost, masked, etc. User interface 300 may be configured to use the profile name and/or image in notifications to the user or other users.

Referring to FIG. 4, embodiments user interface 300 may include any or all of profile description selector 312, status selector 314, broadcast/mood selector 316, user number selector 304 (e.g., phone number), share location selector 318, and blocked contacts selector 320 (e.g., define contacts to be blocked), any or all of which may include visibility selections. User interface 300 may include security operations provided by way of safe shake selector 322 (e.g., to activate or deactivate user-predefined actions using toggle selector 323), user verification selector 324 (e.g., define access control by way of passcode and/or face identification), and multi-step verification selector 326 (e.g., define access control by way of a secondary device for independent verification). With embodiments, visibility selections of user interface 300 may be configured to define the visibility of certain information of a user relative to one or more other users. For example, user interface 300 may be configured such at a user can select information via visibility threshold 111 to be visible to “everyone” including all users of memory 105 or databases 123 of server 127, visible to “my contacts” including all or selected users or user groups of a contact list or library stored on memory 105 or databases 123 of device 101, or visible to “only me” such that it is not visible or invisible to the user or other users.

FIG. 5 illustrates embodiments of user interface 300 having profile selector 302, profile description selector 312, status selector 314, broadcast/mood selector 316, user number selector 304, and location selector 318, any or all of which may include visibility selections. User interface 300 may include blocked contacts 320, safe shake 322, verification selector 324, and multi-step verification selector 326. User interface 300 may include controls 315 having broadcast/mood selector 316, call history selector 328, camera selector 330, chat selector 332, and settings selector 334.

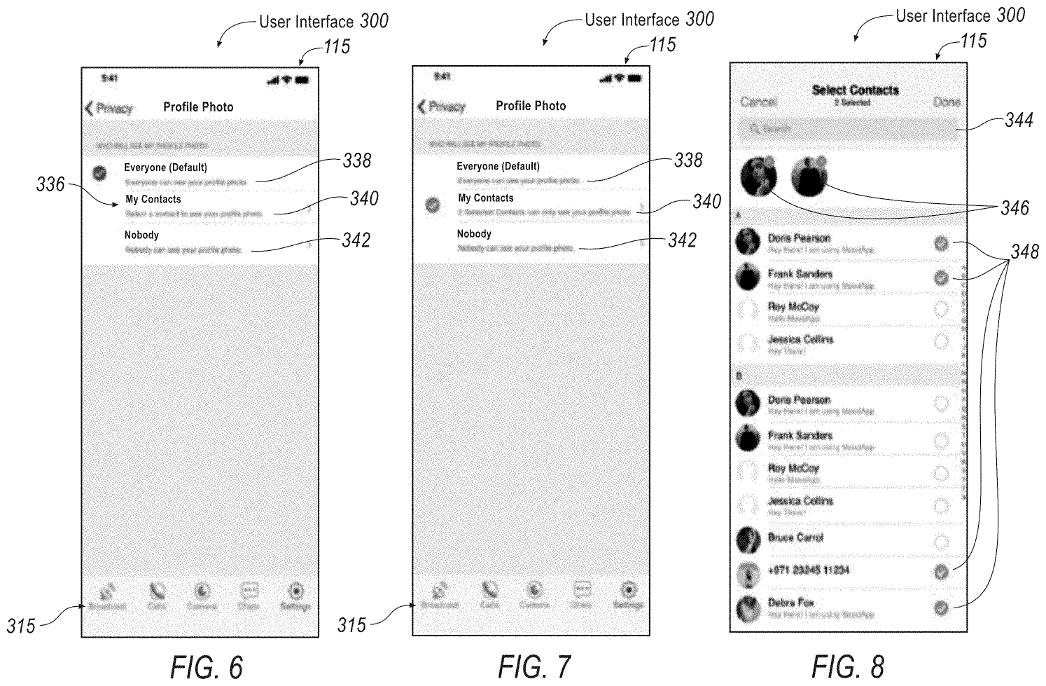

With reference to FIGS. 6-8, embodiments of user interface 300 may be configured to receive selections of one or more users or user groups of a contact list or library of memory 105 or databases 123 of device 101. User interface 300 may include privacy selector 336 for each of the profile image, description, status, broadcast and user number. Privacy selector 336 may include full visibility 338 (e.g., profile image visible to all other users or everyone as a default), partial or limited visibility 340 (e.g., profile image visible to all or selected contacts of the user), and invisibility 342 (e.g., profile image invisible or not visible to other users). As shown in FIG. 6, full visibility 338 may be selected for visibility of the profile image to all other users. As shown in FIG. 7, partial or limited visibility 340 may be selected for visibility of the profile image to only other users that are contacts of the user or a user-selected subset of the contacts. As shown in FIG. 8, user interface 300 may include user search 344, selected user group 346, and user/contact selections 348.

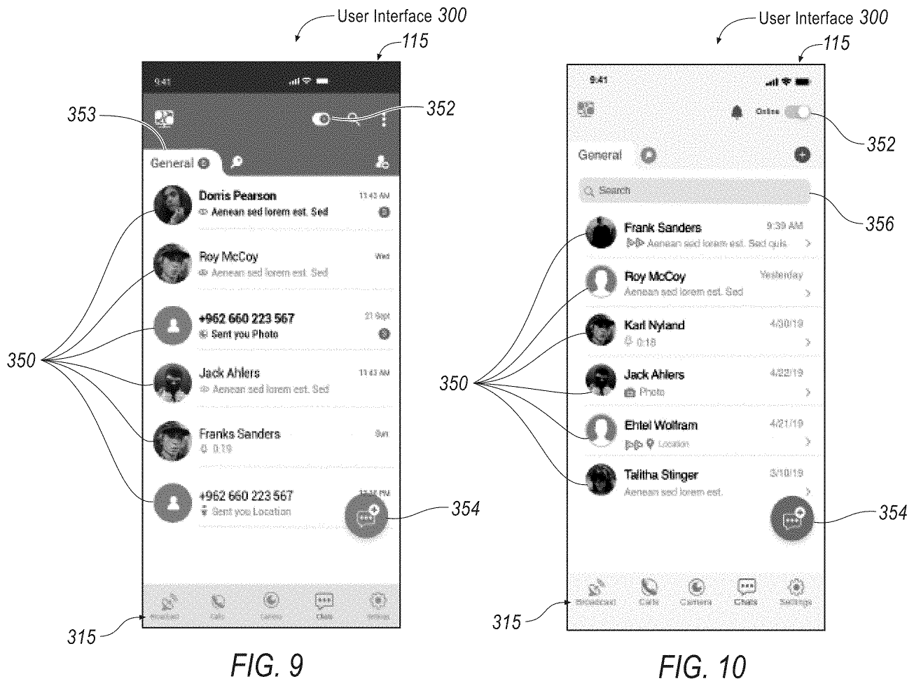

As shown in FIGS. 9-10, embodiments of user interface 300 may include chat listing 350, online/offline selector 352, add/initiate session selection 354, and user search 356. Chat listing 350 may include communication profiles and/or sessions with one or more other users. The communication profiles/sessions may be stored on one or more of memory 105 and databases 123. Each communication session may include text, audio, image or video messages or a combination thereof. User interface 300 may include an online/offline selector 352. User interface 300 may include one or a plurality tabs 353 for respective user profiles, general, official, business, personal, private, ghost, masked, etc. that may be selected by way of display 115 or in response to sensor 121. User interface 300 may include add session selection 354 configured to initiate a communication session with one or more additional users or user groups.

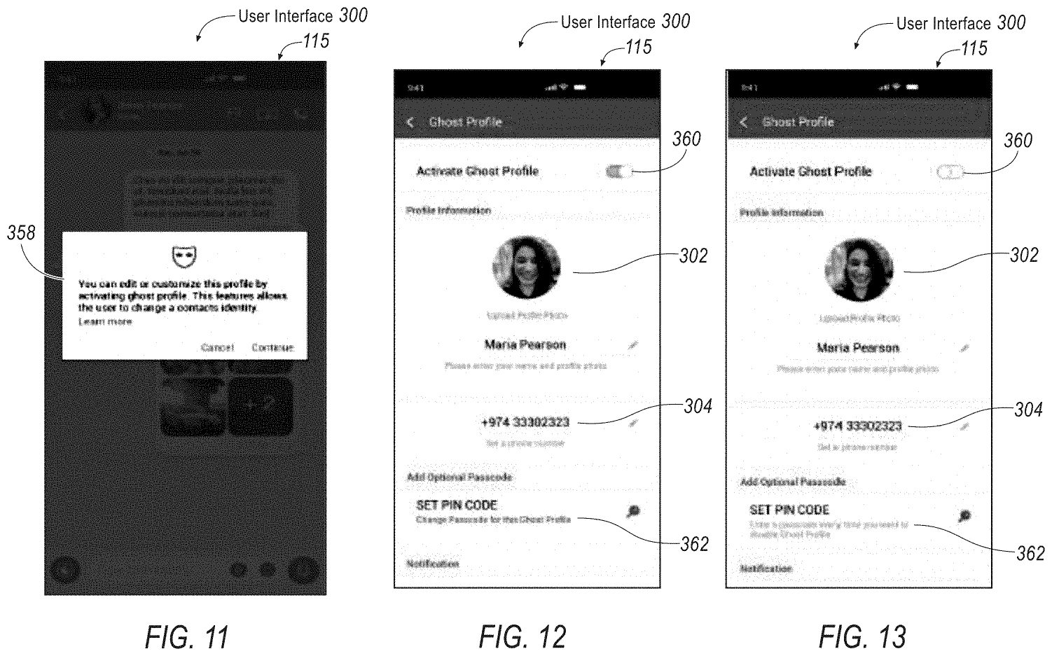

Referring to FIGS. 11-15, embodiments of user interface 300 may be configured to provide a ghost or masked profile for masking a user profile of one or more other users, e.g., to maintain user privacy and security. As shown in FIG. 11, user interface 300 may include ghost or masked initiation box 358 that may be activated by the user to mask a user profile of the user or another user with a ghost or masked profile that changes or replaces the identity of that user. User interface 300 may include ghost or masked profile toggle selector 360 having an activated condition (FIG. 12) and deactivated condition (FIG. 13). User interface 300 may include profile selector 302, user number 304, and access permissions area 362.

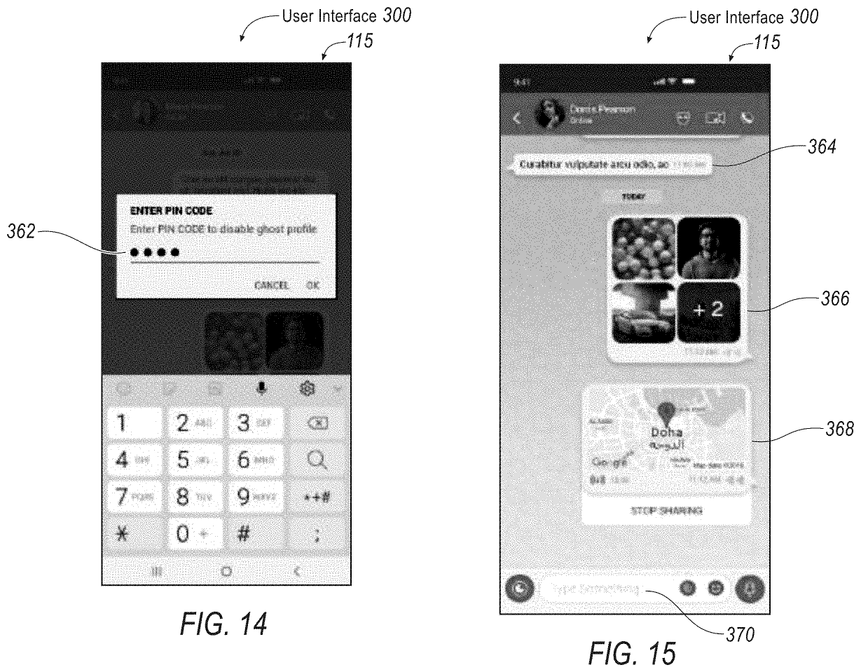

As shown in FIG. 14, access area 362 may be configured to receive a pin code to setup and disable the ghost or masked profile. User interface 300 may be configured to display a baseline profile including actual profile information in the deactivated condition and a ghost or masked profile masking the actual profile with masked information in the active condition. The ghost or masked profile may include a user-predefined or randomly generated user image, description and/or number to mask the actual user profile.

As shown in FIG. 15, the masked information of the ghost or masked profile may include selectively masked text 364, masked images 366, and user mood information 368 (e.g., masked user location), e.g., selectively translated or coded into alternative or misleading text, images and/or locations that are different than the actual information of the baseline profile. User interface 300 may include user input area 370 to enter and/or search text relative to the masked information of the ghost or masked profile.

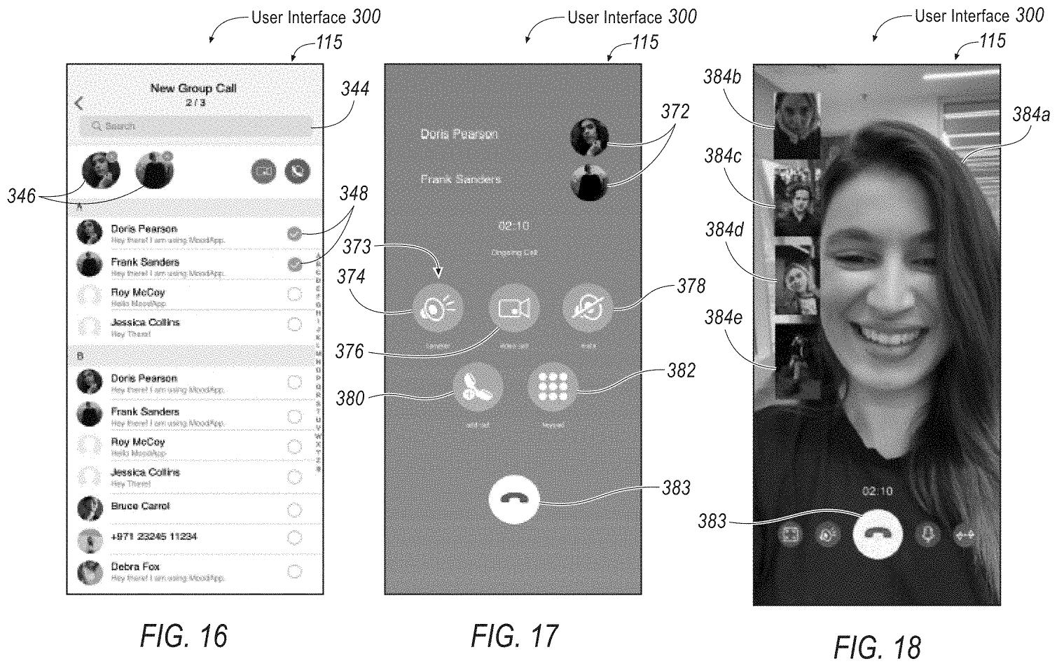

With reference to FIGS. 16-18, embodiments of user interface 300 may include user search 344, selected user group 346, and user/contact selections 348. As shown in FIG. 17, user interface 300 may include one or more communication profiles/sessions 372 with other users, and call controls 373. Call controls 373 may include speaker selection 374, video selection 376, mute selection 378, add call selection 380, and keypad 382. As shown in FIG. 18, user interface 300 may include a plurality of messages for one or more communication profiles/sessions 384a, 384b, 384c, 384d, 384e for corresponding users, e.g., text, audio or video chat sessions.

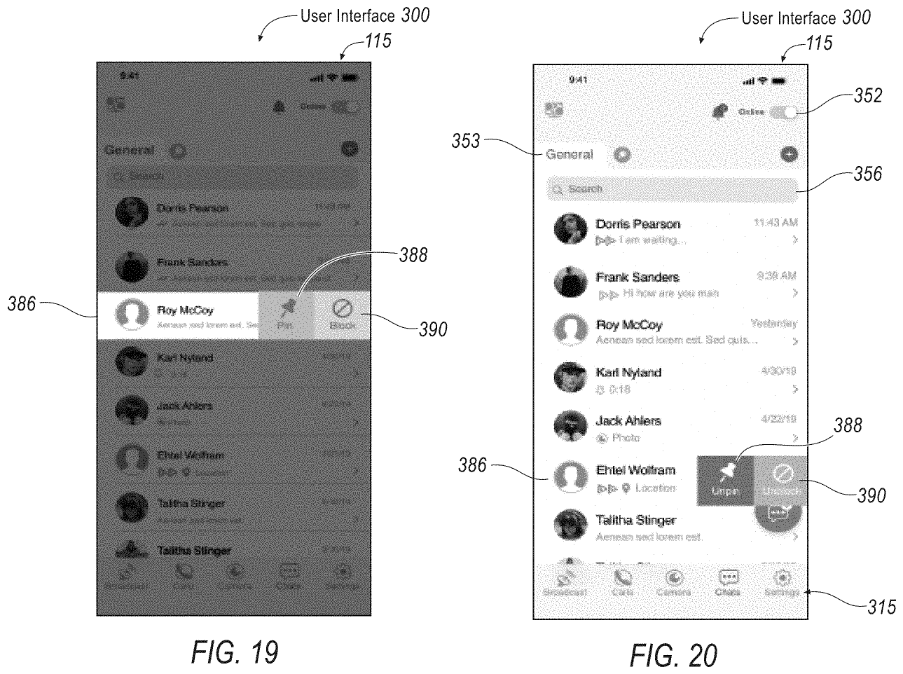

Referring to FIGS. 19-20, embodiments of user interface 300 may include user selection 386 having pin 388 and block 390. Pin 380 may be configured to pin a desired or important user to a designated area of user interface 300, e.g., an upper or top area. Block 390 may be configured to block an undesired or unimportant user.

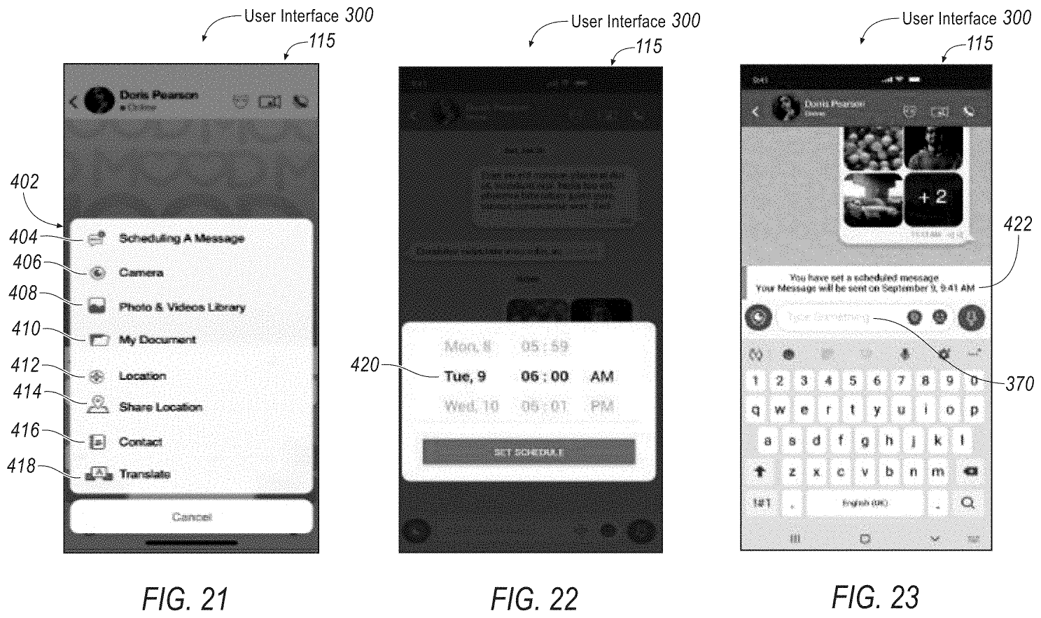

FIGS. 21-23 illustrate embodiments of user interface 300 having selection menu 402 configured to launch one or a plurality of operations as disclosed herein. User interface 300 may include message scheduler 404, camera 406, media library 408 (e.g., images, photos, audio, and/or videos), documents 410, location 412, share location 414, contact list or library 416, and translate 418. As shown in FIG. 22, user interface 300 may include message scheduler 420 for selecting a future date and time for automatically initiating a communication session with the user or another user, e.g., a message to be automatically sent at the selected date. As shown in FIG. 23, user interface 300 may be configured to provide notification indicator 422 that the communication session is scheduled and will be sent at the selected date and time. User interface 300 may include user input area 370 to enter and/or search text relative to prior and scheduled communication profiles/sessions.

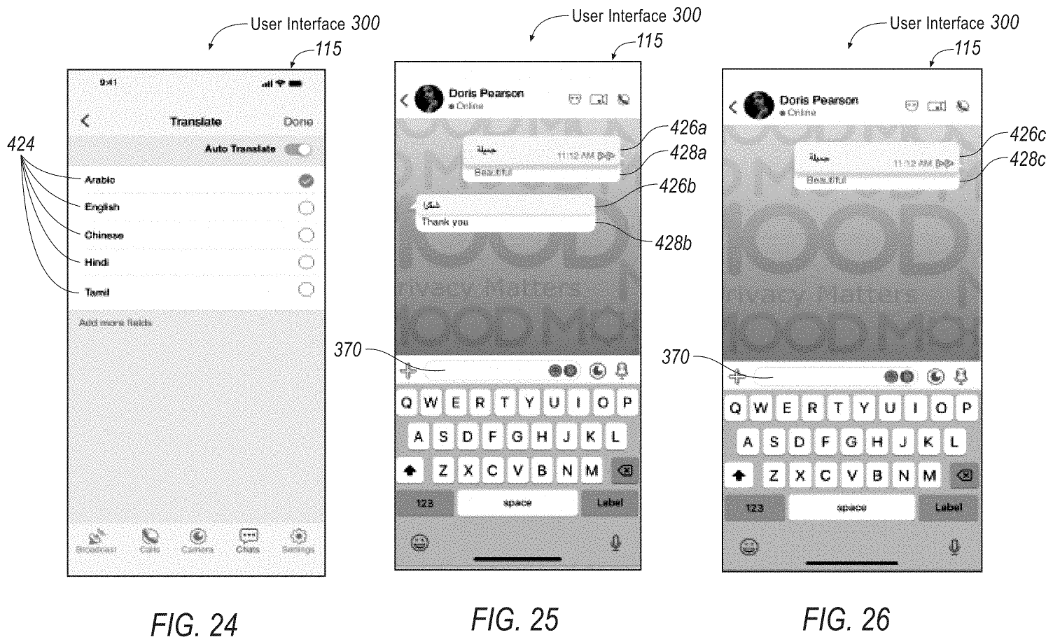

As shown in FIGS. 24-26, embodiments of user interface 300 may be configured for automatic or on-demand language translation according to user-predefined selections. User interface 300 may include a plurality of language selections 424. User interface 300 may include communications in multiple languages 426a-c, 428a-c. User interface 300 may include user input area 370. For example, a user may enter text in a first language in user input area 370 and device 101 may on-demand or automatically translate the text into the selected language. The user device 101 may send the entered text and the translated text to the other user (e.g., on-demand or automatically).

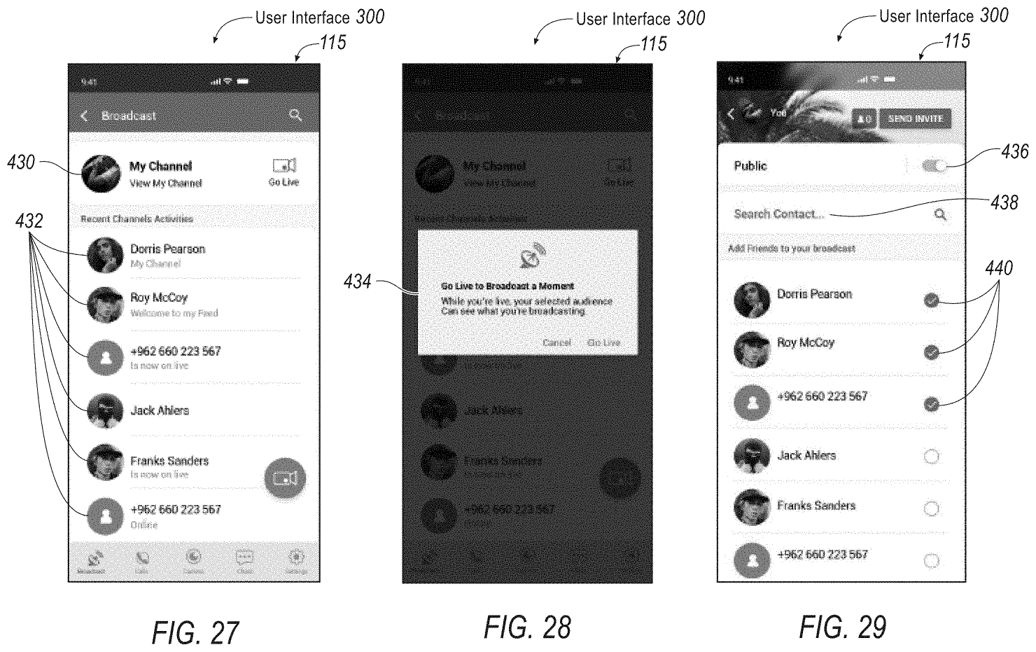

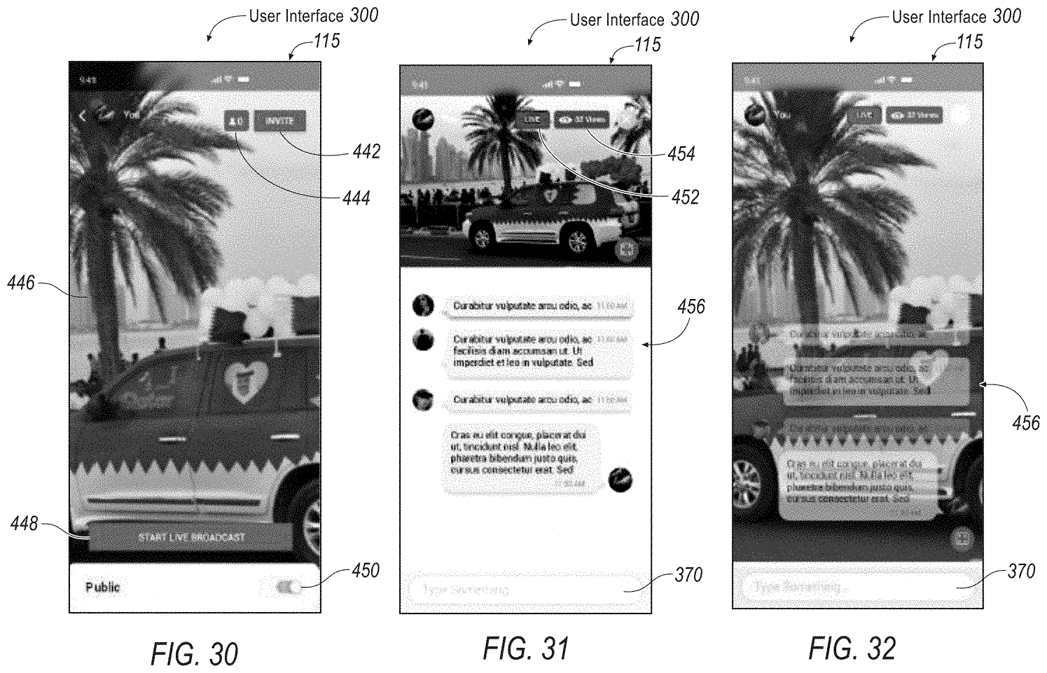

FIGS. 27-34 may include embodiments of user interface 300 configured for broadcasts to a plurality of users. Referring to FIG. 27, user interface 300 may include channel selector 430 for initiating a broadcast to a plurality of selected users channels 432. As shown in FIG. 28, user interface 300 may include activation box 434 to initiate a real-time broadcast of a camera of device 101. With reference to FIG. 29, user interface 300 may include public/private toggle selector 436, user/contact search 438, and contact selections 440. FIG. 30 illustrates user interface 300 including invite 442 to invite additional users, viewer count 444, media broadcast 446, live broadcast starter 448, and public toggle selector 450. Public/private toggle selector 436, 450 may be configured to allow or restrict public access to the broadcast content 446. As shown in FIGS. 30-32, user interface 300 may include a text area above, below, side-by-side or superimposed over media broadcast 446. User interface 300 may include live button 452, view counter 454, text area 456, and user input area 370.

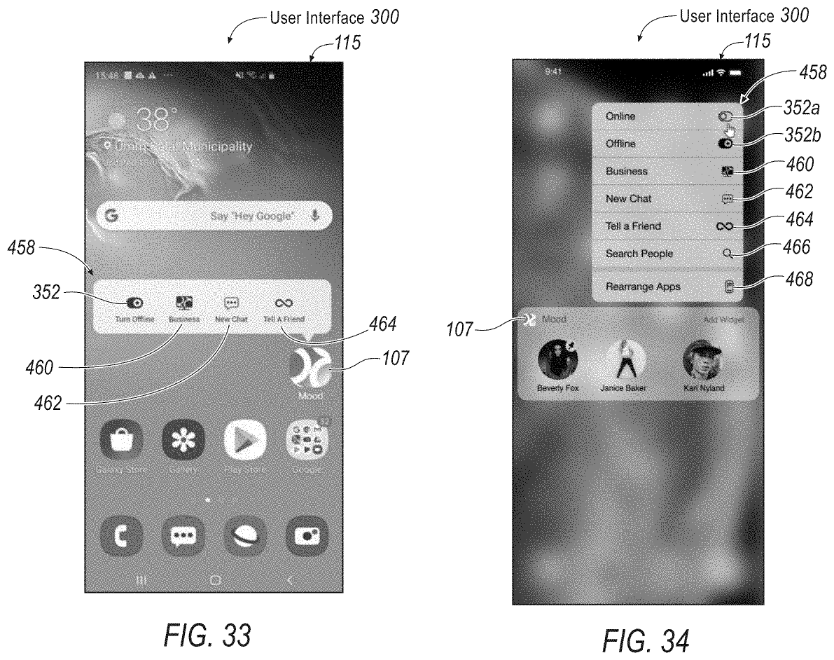

Referring to FIGS. 33-34, user interface 300 may include embodiments configured for pre-launch operations. User interface 300 may include online/offline selector 352, profile launcher 460 (e.g., directly launches a predefined profile of a user such as a business or personal profile), chat launcher 462 (e.g., launches directly into a communication session with one or more users/sessions), invite launcher 464 (e.g., sends a message and/or link including application 107 to other users such as contacts or friends), search people launcher 466 (e.g., search databases 123 for other users), and rearrange apps 468.

User interface 300 may a multi-level visibility selector 352a,b. Selector 352a may be configured to selectively change between online and offline connectivity to network 129, real-time communicator device 125, and/or servers 127a-b. Selector 352b may be configured to selectively change between online and offline appearance to other users, e.g., depending on or independently of connectivity. For example, selector 352a and selector 352b may be set to match each other with online connectivity and appearance, or offline connectivity and appearance. Alternatively, selector 352a may be set to online to provide connectivity while selector 352b is set to offline to give an offline appearance to other users, or selector 352a may be set to offline to disconnect connectivity while selector 352b is set to online to give an online appearance to other users. The multi-level selector 352a,b may also be configured to selectively change between online and offline connectivity and/or appearance in response to user-predefined operations, e.g., based on the online and offline connectivity and/or appearance of other users.

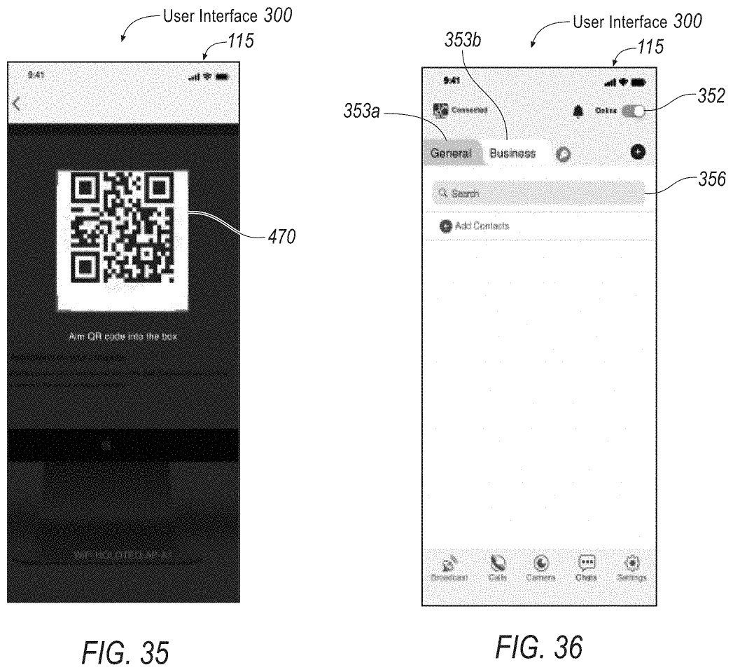

With reference to FIG. 35, embodiments of user interface 300 may be configured for quick launch of a profile of a user. User interface 300 may be configured to display pattern 470, e.g., a locator, identifier or tracker that points to a website or application. Pattern 470 may include a machine-readable image, matrix, barcode, or quick response (QR) code. Device 101 associated with a user profile may be configured to display pattern 470 associated with the user profile and pattern 470 may be read by another device 101 for display of the user profile. For example, device 101a may display pattern 470 of one or more user profiles, which may be read and displayed by devices 101 of one or more users.

Referring to FIG. 36, embodiments of user interface 300 may include one or a plurality of tabs 353. Tabs 353a,b may be associated with respective user profiles such as general, official, business, personal, private, ghost, masked, etc. This allows user device 101 to shift between and display various user profiles associated with tabs 353, e.g., in response to user inputs via display 115 and/or sensor information via sensor 121.

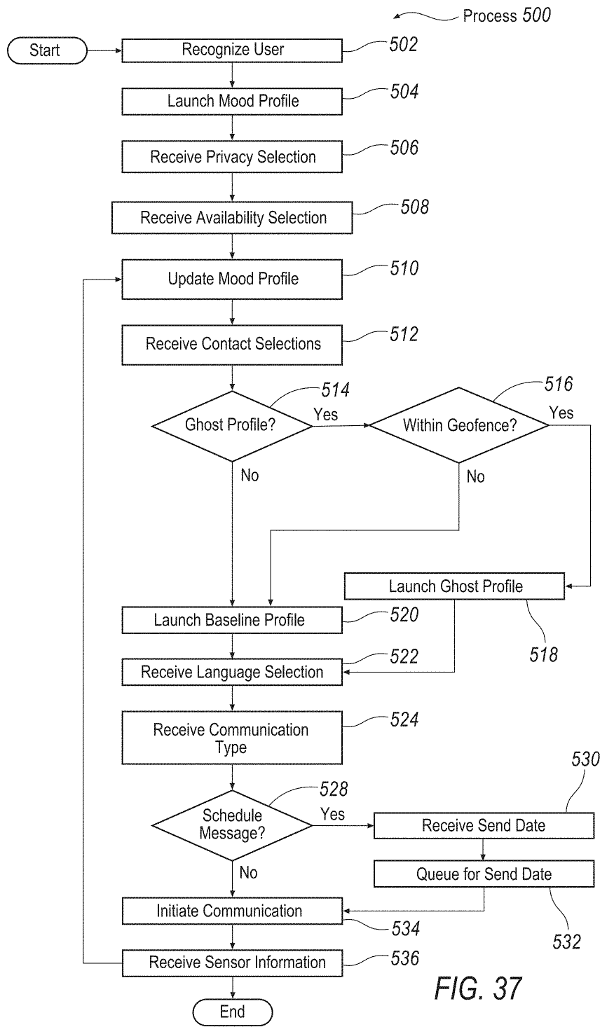

FIG. 37 illustrates an exemplary process 500 for providing the operations disclosed herein. Embodiments of process 500 may take many different forms and include multiple and/or alternate components and/or implementations. While an exemplary process is shown in the figure, the illustrations are not intended to be limiting. Indeed, additional or alternative components and/or implementations may be used.

At block 502, system 100 (e.g., using devices 101 and/or servers 127) may prompt for and/or receive user/mood information, e.g., by way of real-time user inputs from display 115 and/or prior user inputs from memory 105, databases 123, network 129 or a combination thereof. System 100 may recognize a first user profile by comparing (e.g., using processor 103) the user inputs with user profiles, e.g., on memory 105 and/or databases 123.

At block 504, system 100 may launch (e.g., by processor 103) and display (e.g., by display 115) a user profile corresponding with the user inputs.

At block 506, system 100 may prompt for and/or receive a privacy selection of the user or user profile, e.g., by way of real-time user inputs from display 115 and/or prior user inputs from memory 105, databases 123, network 129 or a combination thereof.

At block 508, system 100 may prompt for and/or receive an availability selection of the user or user profile, e.g., by way of real-time user inputs from display 115 and/or prior user inputs from memory 105, databases 123, network 129 or a combination thereof

At block 510, system 100 may update (e.g., by processor 103) the user profile on memory 105 and/or databases 123.

At block 512, system 100 may prompt for and/or receive one or more content selections of the user, e.g., by way of user inputs from display 115.

At decision point 514, system 100 may prompt for and/or receive a ghost or masked profile selection by way of display 115. System 100 may receive either a selection of activate ghost or masked profile and proceed to decision point 516, or a selection of deactivate ghost or masked profile and proceed to block 520.

At decision point 516, system 100 may determine a user location by way of location positioning device 119 and determine by processor 103 whether the user location is within a user-predefined geofence area, e.g., by way of real-time user inputs from display 115 and/or prior user inputs from memory 105, databases 123, network 129 or a combination thereof If the user location is within the geofence, system 100 may proceed to block 418. If the user location is outside the geofence, system 100 may proceed to block 520.

At decision point 518, system 100 may launch by processor 103 and display 115 a ghost or masked profile from memory 105 and/or database 123.

At block 520, system 100 may launch by processor 103 a baseline profile including the actual profile information of the user, e.g., from memory 105 and/or database 123.

At block 522, system 100 may prompt for and/or receive one or more language selections of the user, e.g., by way of real-time user inputs from display 115 and/or prior user inputs from memory 105, databases 123, network 129 or a combination thereof.

At block 524, system 100 may prompt for and/or receive a communication type from the user, e.g., by way of user inputs from display 115.

At decision point 528, system 100 may prompt for and/or receive (e.g., by display 115) a selection for a communications session. If display 115 receives a user input to schedule a communication session for user-predefined date, the system 100 may proceed to block 530. If display 115 receives a user input to proceed with the communication session, the system 100 may proceed to block 534.

At block 530, system 100 may prompt for and/or receive a send date, e.g., by way of display 115.

At block 532, system 100 may prompt for and/or receive a send date, e.g., by way of display 115.

At block 534, system 100 may prompt for and/or receive user inputs by way of display 115 and/or sensor 121 to initiate and send a communication session based on the user inputs.

At block 536, system 100 may receive (e.g., by way of sensor 121) sensor information associated with the user. System 100 may update user profile based on the sensor information. After block 536, process 500 may end or return to any other step such as block 510.

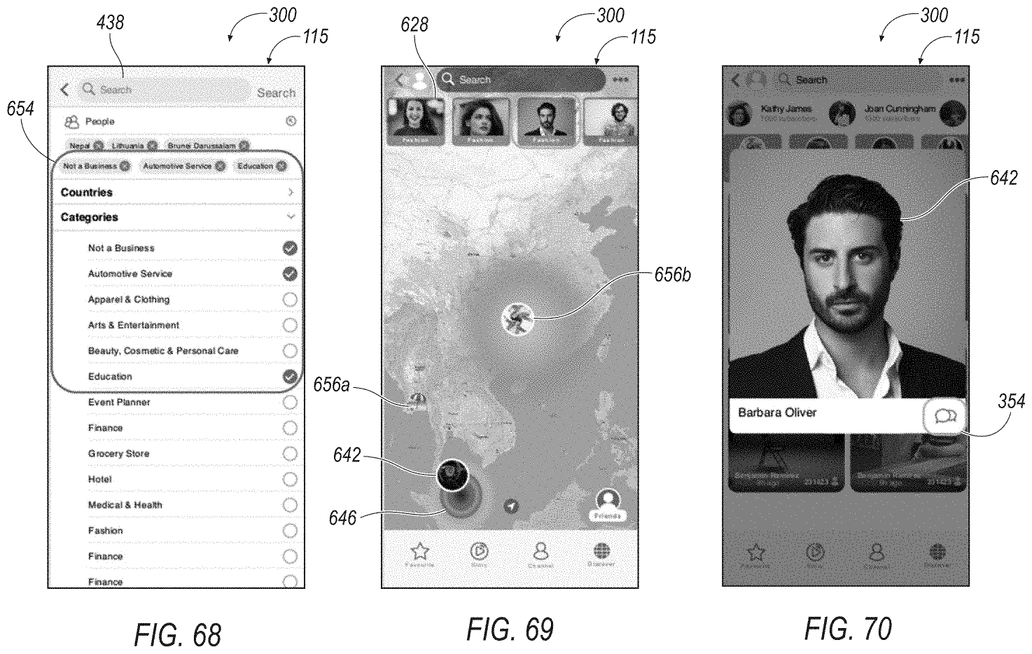

FIGS. 38-70 illustrate more exemplary embodiments of user interface 300. User interface 300 may include display device 115 configured to present and display information, receive user inputs, and provide the operations disclosed herein. With embodiments, user interface 300 may include visibility selections, advanced message scheduling, automatic or on-demand translations, and interactive broadcasting. User interface 300 may take many different forms and include multiple and/or alternate components and/or implementations. While an exemplary device is shown in the figures, the illustrations are not intended to be limiting. Indeed, additional or alternative components and/or implementations may be used.

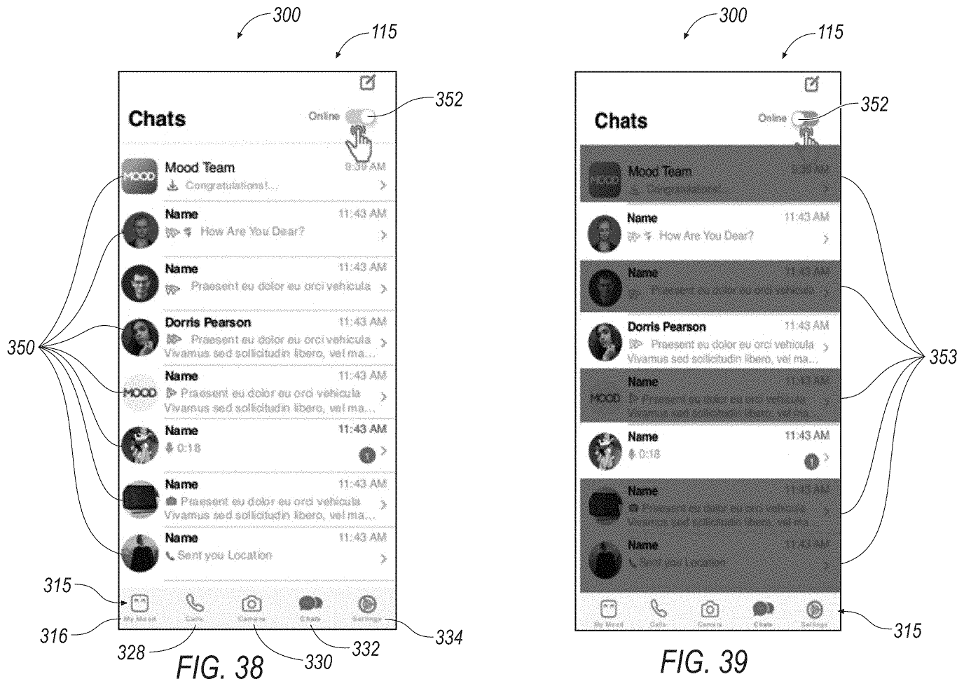

As illustrated in FIGS. 38-39, embodiments of user interface 300 may include display device 115 having call controls 315, chat listing 350, and online/offline selector 352. Controls 315 may include broadcast/mood selector 316, call history selector 328, camera/image selector 330, chat selector 332, and settings selector 334. Online/offline selector 352 may sequentially or simultaneously mask communications with one or more users of chat listing 350.

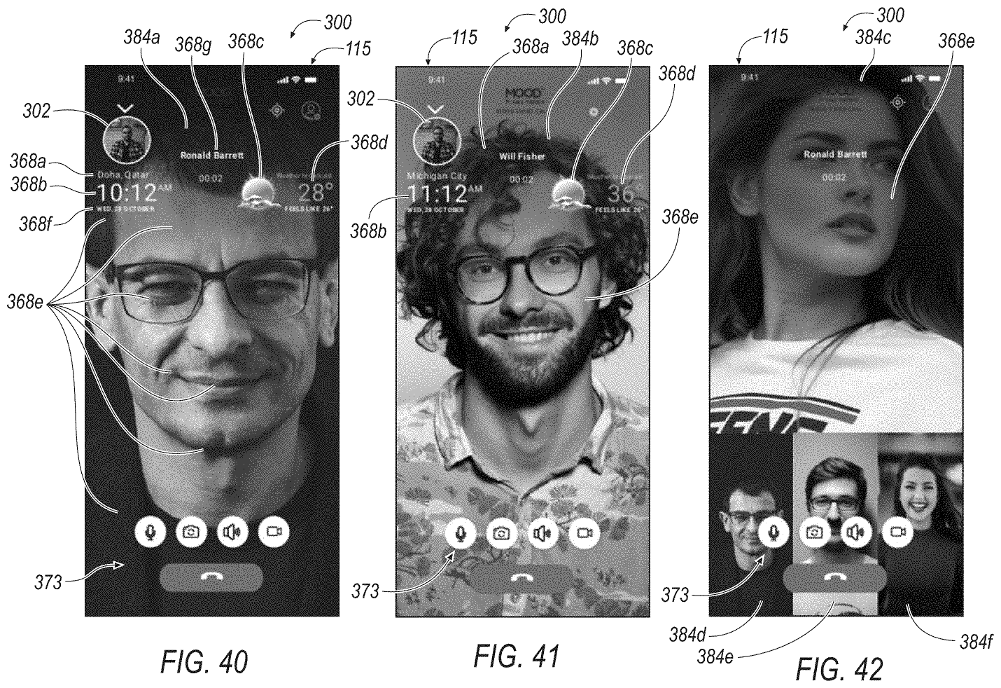

FIG. 40-42 illustrate user interface 300 including display device 115 having profile selector 302, user mood information 368, call controls 373, and one or more communication profiles/sessions 384 for corresponding users. User interface 300 may provide communication profiles/sessions 384a,b,c,d,e,f for respective first, second, third, fourth, fifth, and/or sixth users, and any additional number of users. User mood information 368 may include one or more static, dynamic or adaptive features including geographic location 368a, time 368b, weather 368c, temperature 368d, mood characteristics 368e (e.g., mood information and associated thresholds for facial conditions/expressions), date 368f, and descriptive data 368g (e.g., user and/or message information).

Mood information and associated thresholds may include user inputs via display 115, sensor information via sensor 121, or a combination thereof. Mood information may include location, weather, time, temperature, facial expression, voice stress, posture, and attire. Facial conditions/expressions may include facial affect, hair condition, hair style, eyebrow furrow, squint, makeup/no makeup, wrinkles, nasolabial folds, mouth crease, smile/frown, gestures, mouth open/closed, and chin position/orientation. Voice stress may include voice speed, pitch, and/or tone. Attire may include style, condition, presence and type of clothes (e.g., formal vs. informal) and accessories (e.g., glasses and/or hats). User interface 300 may be receive and automatically adapt indicators on display 115 in response mood information and associated thresholds for mood characteristics 368e of one or more users.

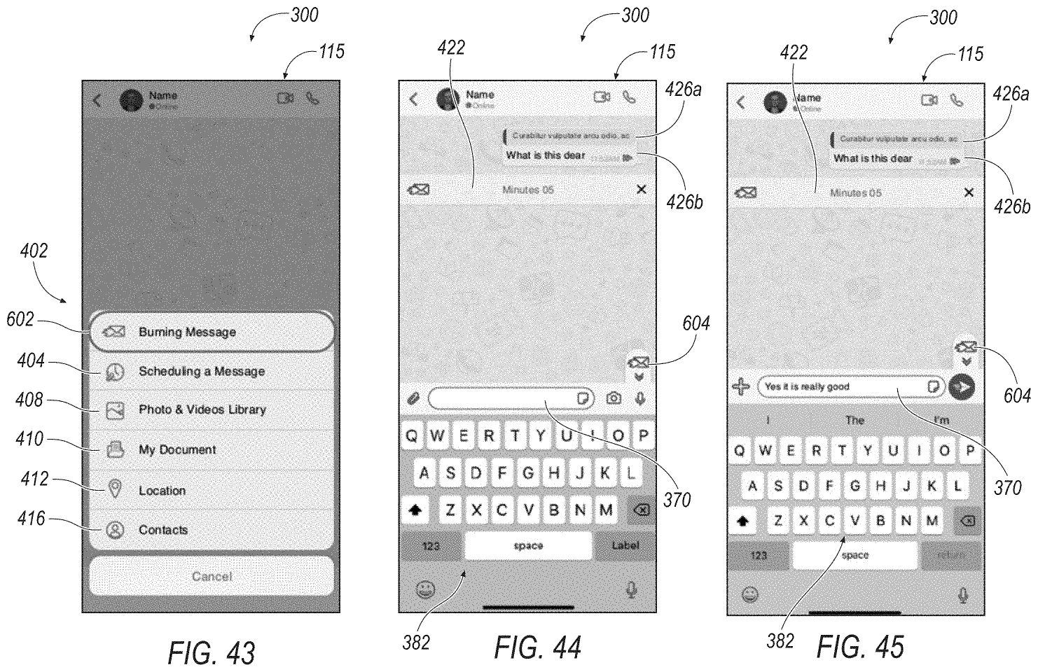

As shown in FIGS. 43-50, user interface 300 including display 115 may include section menu 402 configured to launch one or a plurality of operations as disclosed herein. User interface 300 may be configured to generate selection menu 402 including burning message 602, message scheduler 404, camera 406, media library 408 (e.g., images, photos, audio, and/or videos), documents 410, location 412, share location 414, contact list or library 416, and translate 418. Referring to FIG. 44, user interface 300 may be configured to generate burning message activator 604, user input area 370, keypad 382, notification indicator 422, and message 426a,b (e.g., multi-language).

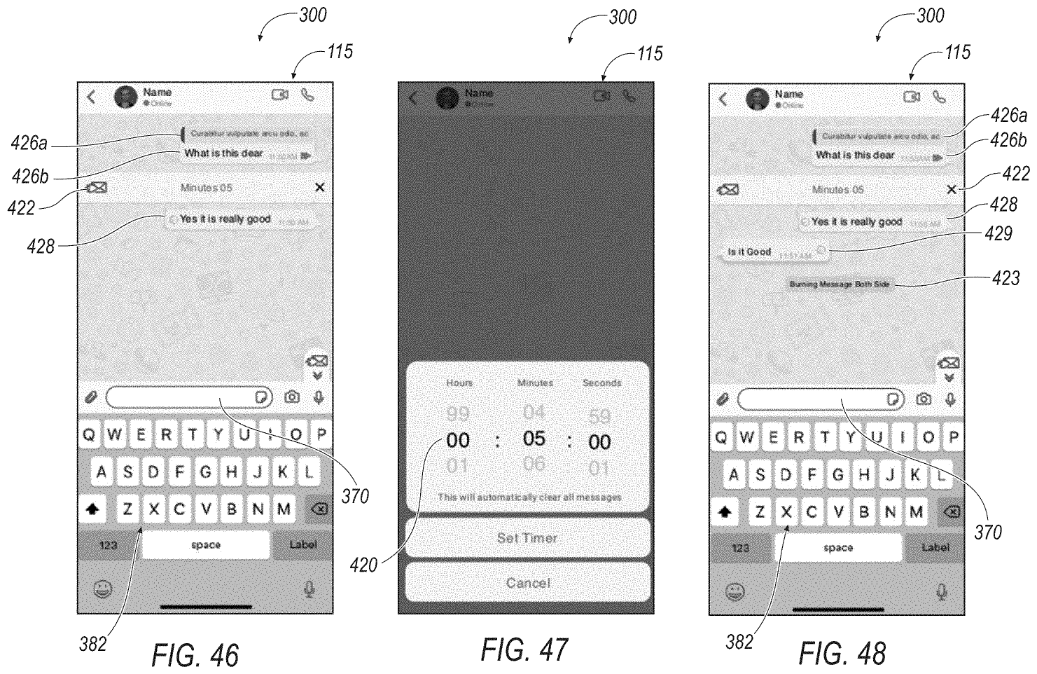

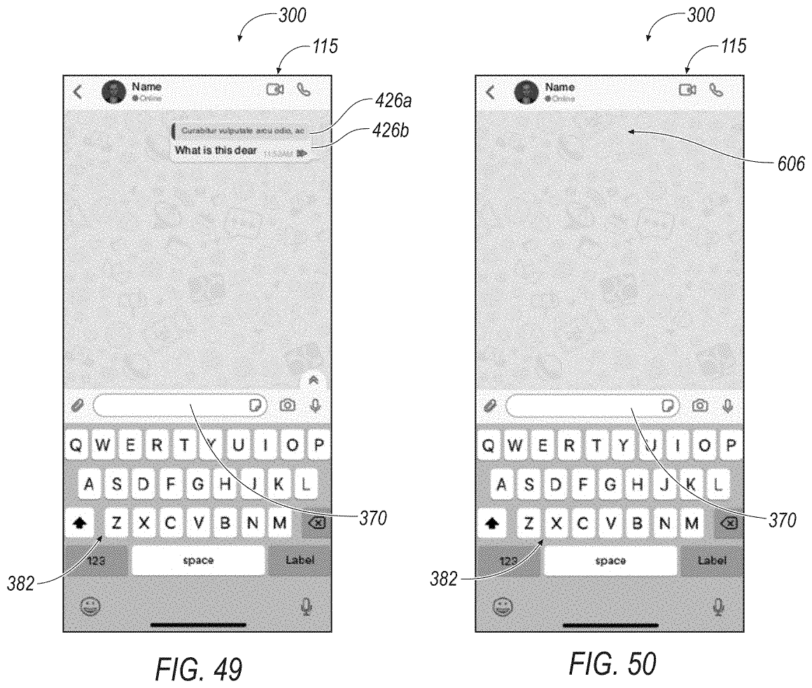

Notification indicator 422 of one or more burning messages may have a predefined or user-defined duration. FIG. 45 illustrates user input area 370 configured to receive content (e.g., text, audio, or video) as part of message 426a,b (e.g., a burning message). As shown in FIG. 46, user interface 300 may display notification indicator 422 of message 426a,b of one or more users and having a predefined or user-defined duration. User interface 300 as shown in FIG. 47 may be configured to define the predefined or user-defined duration. As shown in FIG. 48, user interface 300 may display messages 428, 429 of one or more users associated with a second notification indicator 423. User interface 300 of FIGS. 49-50 illustrates sequential or simultaneous disappearance of messages 426a, 426b, 428, 429 for one or more users to provide a burned or cleared message area 606 according to the respective predefined or user-defined durations of the first and second notification indictors 422, 423.

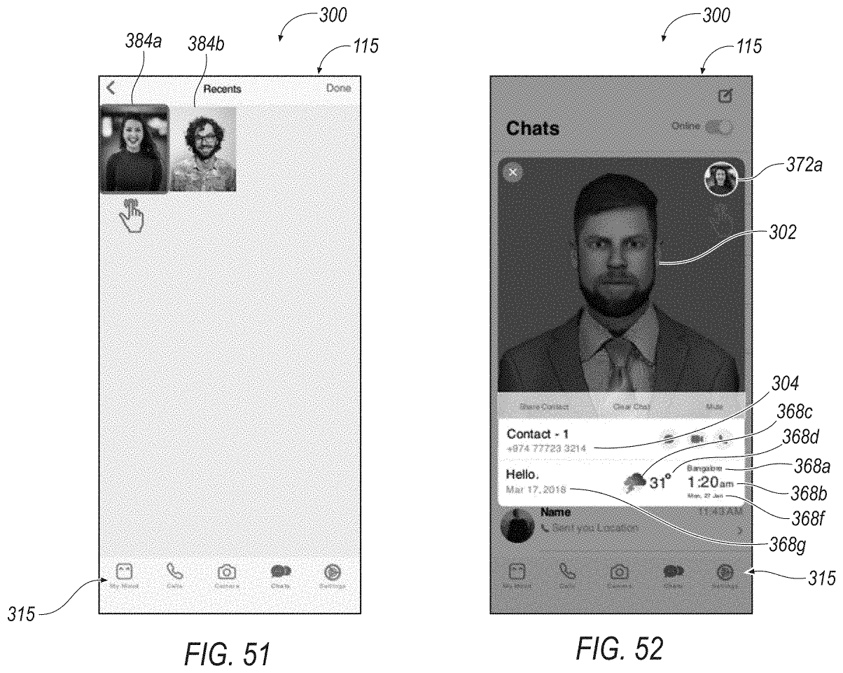

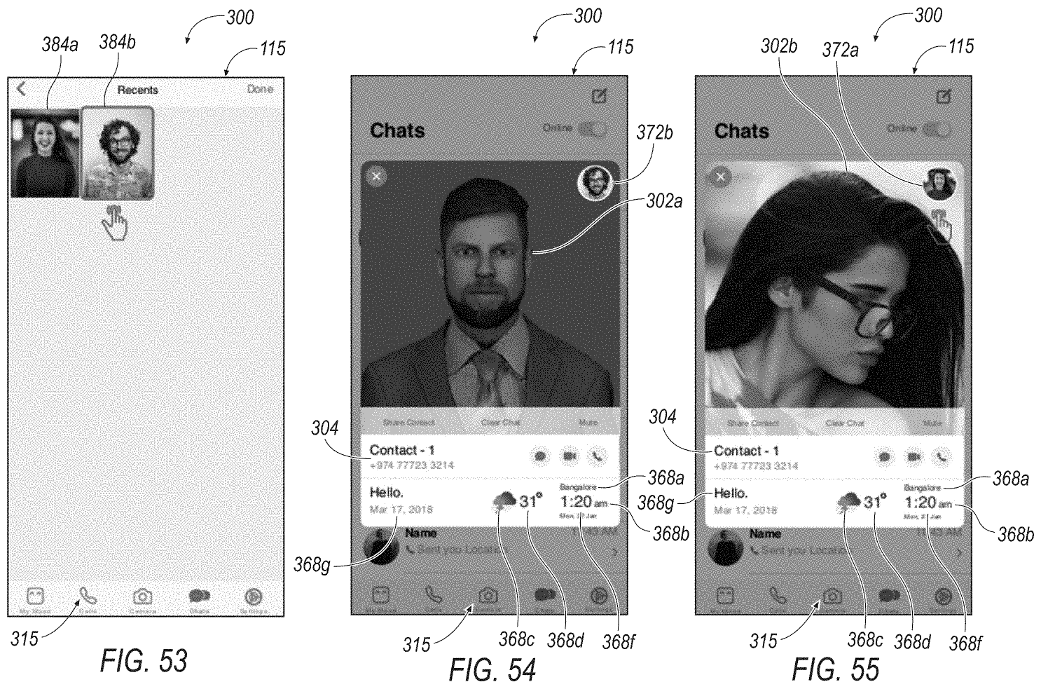

FIGS. 51-55 illustrate user interface 300 with display 115 having adaptive mood profiles. User interface 300 of a first user may include communication profiles/sessions 384a,b for corresponding second and third users. Mood profile selector 302 may adapt in response to each of communication profiles/sessions 384a,b. Mood profile selector 302 may include profile selector 302 configured to adapt user number 304 and user mood information 368 depending on communication profile/session 384, e.g., user mood information 368 being different for each of communication profiles/sessions 384a,b. As shown in FIGS. 51 and 53, user interface 300 may be configured to select one of communication profiles/sessions 384a,b and define each of profile selectors 302a,b to respond differently depending on the selected communication session 384a,b. As shown in FIGS. 52 and 54-55, profile selectors 302a,b (e.g., profile images) and user mood information 368 may adapt in response to the selected communication session 384a,b.

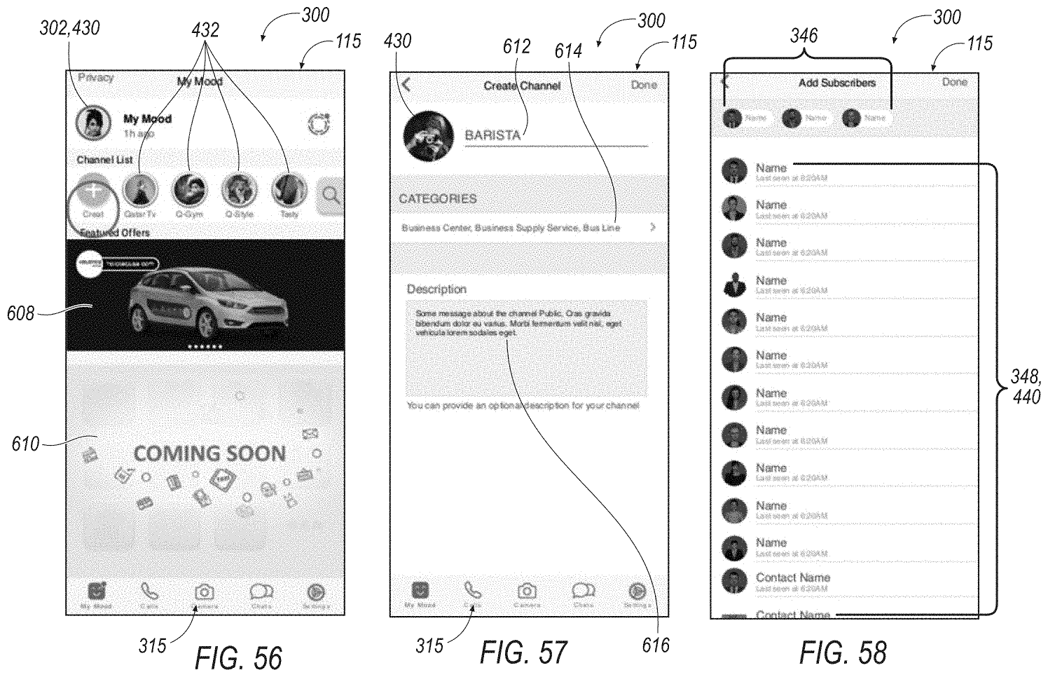

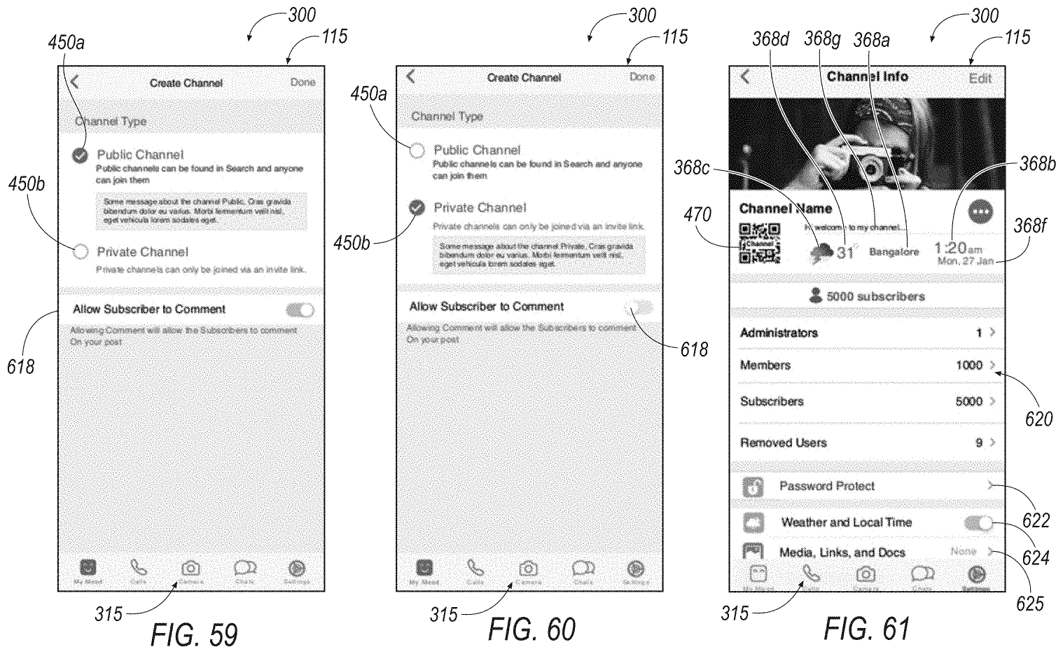

Referring to FIGS. 56-61, user interface 300 may include display 115 configured to broadcast and adapt multiple channels according to profile selector 302 and/or channel selector 430. User interface 300 as shown in FIG. 56 may include a plurality of user channels 432, advertising offers 608, and content previews 610. FIG. 57 may include user interface 300 configured to create one or more channels including title 612, categories 614, and description 616. As shown in FIG. 58, user interface 300 may include selected subscribers 346 and user/content selections 348, 440. As shown in FIGS. 59-60, user interface 300 may public/private channel selections 450a,b and toggle selector 618 (e.g., to allow subscriber comments). FIG. 61 illustrates user interface 300 with channel information, e.g., display pattern 470, user mood information 368, user analytics 620 (e.g., administrator, member, subscriber, and removed user volumes and heuristics), password selector 622, weather and local time selector 624, and content selector 625 (e.g., media, links, and documents). User interface 300 of one or more users of devices 101 may adapt in response to user, mood and/or sensor information of one or more other users of devices 101.

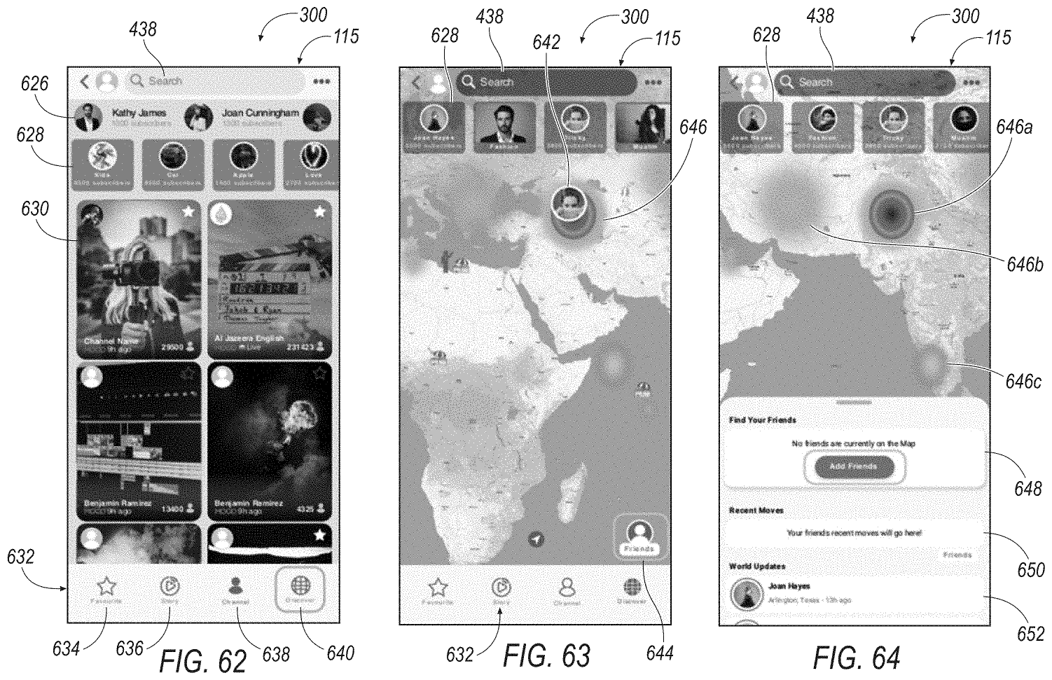

FIGS. 62-70 include user interface 300 with display 115 configured to optimize user searches and connections. As shown in FIG. 62, user interface 300 may include contact search 438, selected users/contacts 626, selected channels 628, selected media 630, and channel controls 632. Channel controls 632 may include selected favorites 634, selected story 636, selected channels 638, and discover search 640. FIG. 63 illustrates user interface 300 having contact suggestion 642, selected friends/contacts 644, and associated heat mapping 646 based on geographic saturations of similarities between user information, user mood profiles, selected content and performed searches. As shown in FIG. 64, user interface 300 may include heat mapping indicators 646a,b,c for multiple geographic saturations, friend/contact search 648, recent moves/activities 650 of selected friends/contacts, and world news/updates 652.

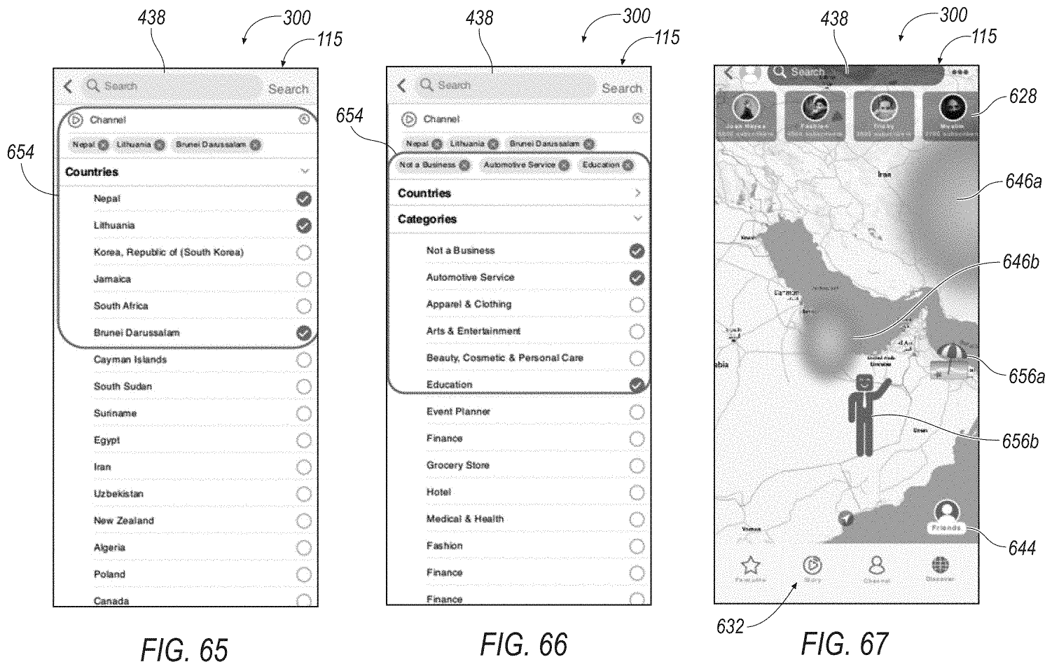

FIGS. 65-66 and 68 illustrate selectors 654 for countries and categories. FIG. 67 illustrates heat mappings 646a,b and attraction indicators 656a,b. FIG. 69 illustrates contact suggestion 642, heat mapping 646, and attraction indicators 656a,b. As shown in FIG. 70, user interface 300 includes suggested contact 642 and add/initiate session selection 354 in response to geographic saturations, user information, user mood profiles, selected content and performed searches.

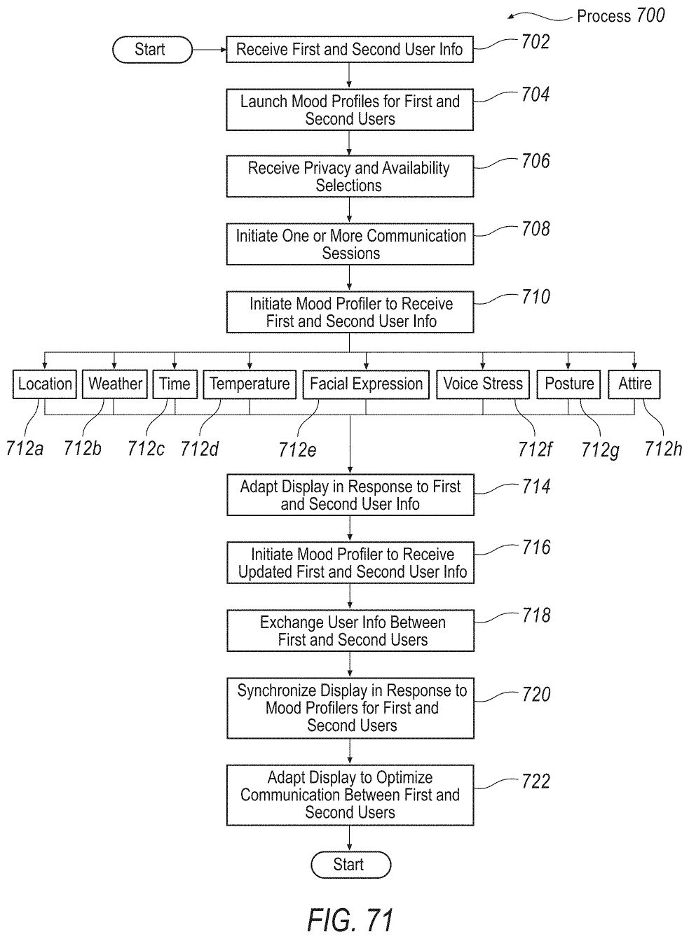

FIG. 71 illustrates an exemplary process 700 for providing the operations disclosed herein. Embodiments of process 700 may take many different forms and include multiple and/or alternate components and/or implementations. While an exemplary process is shown in the figure, the illustrations are not intended to be limiting. Indeed, additional or alternative components and/or implementations may be used.

At block 702, system 100 (e.g., using devices 101 and/or servers 127) may prompt for and/or receive user information of first and second users of first and second devices 101, e.g., by way of real-time user inputs from display 115 and/or prior user inputs from memory 105, databases 123, network 129 or a combination thereof. System 100 may recognize a first user profile by comparing (e.g., using processor 103) the user inputs with user profiles, e.g., on memory 105 and/or databases 123.

At block 704, system 100 may launch (e.g., by processor 103) and display (e.g., by display 115) user mood profiles for the first and second users of devices 101, e.g., corresponding with the user inputs.

At block 706, system 100 may prompt for and/or receive (e.g., by display 115) privacy and availability selections of devices 101 of the first and second users, e.g., by way of real-time user inputs from display 115 and/or prior user inputs from memory 105, databases 123, network 129 or a combination thereof.

At block 708, system 100 may initiate (e.g., by processor 103) one or more communications sessions.

At block 710, system 100 may initiate (e.g., by processor 103) mood profiler to receive user information from devices 101 of first and second users.

At blocks 712, system 100 may prompt for and/or receive (e.g., by display 115) user mood information, e.g., location 712a, weather 712b, time 712c, temperature 712d, facial expression 712e, voice stress 712f, posture 712g, and attire 712h of devices 101 of the first and second users.

At block 714, system 100 may adapt (e.g., by processor 103) display 115 of first and second devices 101 in response to user mood information of the first and second users.

At block 716, system 100 may initiate (e.g., by processor 103) mood profiler to receive updated mood information of first and second users of devices 101.

At block 718, system 100 may exchange (e.g., by transceiver 117 and/or network 129) mood user information between the first and second users of devices 101.

At block 720, system 100 may synchronize (e.g., by processor 103) display 115 of first and second users of devices 101 in response to mood profilers for the other of the first and second users.

At block 722, system 100 may adapt (e.g., by processor 103) display 115 to optimize communication between the first and second users of devices 101. For example, display 115 of one or more devices 101 may provide text, visual, audio and/or tactile indicators reflecting user, mood and/or sensor information of one or more other devices 101, and automatically adapt the indicators, screen brightness, screen color tone, audio volume and/or tactile feedback on each respective device 101 according to a predefined or user-defined actions or objectives according to user inputs via display 115 prior to or during the communication session. After block 722, process 700 may end or return to any other step.

The present disclosure includes processes, systems, methods, and heuristics that may be provided in any ordered, unordered, or random sequence. They may be performed simultaneously and/or may include additional or omitted steps. This disclosure illustrates and describes exemplary embodiments that should not be construed as limiting.

With embodiments, system 100 may include a user interface including a hardware processor, physical memory, and a hardware display. The system 100 may include operations to compare a first user input associated with profile information, recognize the first user input as being associated with a baseline profile, launch the baseline user profile corresponding to the user first input, receive a second user input associated with at least one privacy selection, and update the baseline profile based on the first and second user inputs. The system 100 may prompt for and receive one or more content selections. The system 100 may prompt for and receive at least one of an activation selection and a deactivation selection for a ghost or masked profile associated with the baseline profile, and masking or not masking the baseline profile in response to the respective selection. The system 100 may determine a user location by way of location positioning device, and determine that the user location is at least one of within and outside the user-predefined geofence. The system 100 may prompt for and receive a third user input to launch a second profile configured to mask the baseline profile. The system 100 may prompt for and receive a third user input including at least one of a language selection, a communication type, and a send date, and initiate a communication session based on the first, second and third user inputs. The system 100 may receive sensor information associated with the user, and update the user profile based on the sensor information.

All or any portion of system 100, system 200, user interfaces 300, process 500 and process 700 may be interchanged, omitted or added to any of the embodiments herein. This description is intended to be illustrative and not restrictive. Many embodiments and applications other than the examples provided would be apparent upon reading the above description. The scope should be determined, not with reference to the above description, but should instead be determined with reference to the claims, along with the full scope of equivalents to which such claims are entitled. It is intended that future developments will occur in the technologies discussed herein, and that the disclosed systems and methods will be incorporated into such future embodiments. This disclosure contemplates modification and variation of the underlying innovation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure and not to limit the scope or meaning of the claims. Various features have been grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A user interface system including a hardware processor, physical memory and a hardware display and providing operations comprising:
compare a first user input associated with profile information;
recognize the first user input as being associated with a baseline profile;
launch the baseline user profile corresponding to the user first input; and
receive a second user input associated with at least one privacy selection, and
update the baseline profile based on the first and second user inputs.

2. The user interface system of claim 1, further comprising operations to prompt for and receive one or more content selections.

3. The user interface system of claim 1, further comprising operations to:
prompt for and receive at least one of an activation selection and a deactivation selection for a masked profile associated with the baseline profile; and
mask the baseline profile in response to the activation selection.

4. The user interface system of claim 1, further comprising operations to:
determine a user location by way of location positioning device; and
determine that the user location is at least one of within and outside the user-predefined geofence.

5. The user interface system of claim 1, further comprising to prompt for and receive a third user input to launch a second profile configured to mask the baseline profile.

6. The user interface system of claim 1, further comprising to:
prompt for and receive, by the hardware display, a third user input including at least one of a language selection, a communication type, and a send date, and
initiate a communication session based on the first, second and third user inputs.

7. The user interface system of claim 1, further comprising operations to:
receive sensor information associated with the user; and
update the user profile based on the sensor information.

8. A user interface device including a hardware processor, physical memory and a hardware display and providing operations comprising:
compare a first user input associated with profile information;
recognize the first user input as being associated with a baseline profile;
launch the baseline user profile corresponding to the user first input; and
receive a second user input associated with at least one privacy selection, and
update the baseline profile based on the first and second user inputs.

9. The user interface device of claim 8, further comprising operations to prompt for and receive one or more content selections.

10. The user interface device of claim 8, further comprising operations to:
prompt for and receive at least one of an activation selection and a deactivation selection for a masked profile associated with the baseline profile; and
mask the baseline profile in response to the activation selection.

11. The user interface device of claim 8, further comprising operations to:
determine a user location by way of location positioning device; and
determine that the user location is at least one of within and outside the user-predefined geofence.

12. The user interface device of claim 8, further comprising prompting for and receiving a third user input to launch a second profile configured to mask the baseline profile.

13. The user interface device of claim 8, further comprising to:
prompt for and receive, by the hardware display, a third user input including at least one of a language selection, a communication type, and a send date, and
initiate a communication session based on the first, second and third user inputs.

14. The user interface device of claim 8, further comprising operations to:
receive sensor information associated with the user; and
update the user profile based on the sensor information.

15. A method for a user interface, comprising:
providing a hardware processor, physical memory and a hardware display comparing a first user input associated with profile information;
recognizing the first user input as being associated with a baseline profile;
launching the baseline user profile corresponding to the user first input; and
receiving a second user input associated with at least one privacy selection, and
updating the baseline profile based on the first and second user inputs.

16. The method of claim 15, further comprising prompting for and receiving one or more content selections.

17. The method of claim 15, further comprising operations to:
prompting for and receiving at least one of an activation selection and a deactivation selection for a masked profile associated with the baseline profile; and
masking the baseline profile in response to the activation selection.

18. The method of claim 15, further comprising operations to:
determining a user location by way of location positioning device; and
determining that the user location is at least one of within and outside the user-predefined geofence.

19. The method of claim 15, further comprising prompting for and receiving a third user input to launch a second profile configured to mask the baseline profile.

20. The method of claim 15, further comprising:
prompting for and receiving, by the hardware display, a third user input including at least one of a language selection, a communication type, and a send date;
initiating a communication session based on the first, second and third user inputs;
receiving sensor information from a sensor in communication with the hardware processor; and
updating the user profile based on the sensor information and the first, second and third user inputs.
